(19) United States
(12) Patent Application Publication
(10) Pub. No.: US 2006/0116893 A1
(43) Pub. Date: Jun. 1, 2006

(54) Apparatus and method of collecting and monitoring shipment data

(76) Inventors: Joseph Leland Carnes, Irvine, CA (US); Kim Karen Reinick, Brighton, CO (US); David Jonathan Minns, Trebuco Canyon, CA (US)

Correspondence Address: R. Lewis Gable;Cowan, Liebowitz & Latman, P.C., 1133 Avenue of the Americas, New York, NY, 10036-6799, US

(21) Appl. No.: 10/996,763

(22) Filed: Nov. 24, 2004

(51) Int. Cl. G06Q 99/00; G07G 1/00

(52) U.S. Cl. 705/1; 705/10

(57) ABSTRACT

A system is described for colleting and monitoring shipment data, wherein one or more service providers can enter into the system shipment data that is indicative of the attributes of a plurality of customer shipments as one or more customers forwards at least one customer shipment through a shipment-cycle. The shipment data reflects the attributes of each customer shipment and/or events occurring to at least one customer shipment during its shipment cycle. The collecting and monitoring system comprises a plurality of customer terminals, a web server, a central computer and a plurality of disparate shipment data input terminals, a plurality of customer terminals, a web server, a central computer and a plurality of disparate shipment data input terminals. Each of the plurality of customer terminals comprises a customer display, a customer computer and a customer data input device, the customer computer being programmed to facilitate the customer to input using its data input device a request for the shipment data of one or more of the customer's shipments. The web server comprises a server memory for storing web pages for facilitating at least one customer to enter a request for shipment data. The central computer comprises a shipment tracking data base for receiving and storing shipment data. The central computer is programmed for receiving and storing shipment data in the shipment tracking data base. Each of the plurality of disparate shipment data input terminals enters shipment data into the system which includes a synchronous terminal computer and an asynchronous terminal computer. The central computer being programmed to access from the shipment data elements that are used to determine the compliance statistics and whether shipment data has been entered in each core data element of each shipment. The system further includes a plurality of customer data input devices for requesting shipment data corresponding to criteria entered by a customer.

### FIELD OF THE INVENTION

This invention relates to the near-real-time tracking of shipments being transported worldwide, using processes that increase the ease and completeness with which shipment data can be entered, and using processes that monitor compliance with data entry standards, in a system that allows for additional data elements to be added on demand of the company or customer without the need for additional system programming, making the data available for reporting functions.

### BACKGROUND FOR THE INVENTION

Computer systems in the shipping industry are known for processing data associated with transporting shipments; a shipment being a parcel or group of parcels that a customer has contracted with the transportation company to have transported from one location to another. This data may be used in the day-to-day operations of shipping, as well as for providing customers with information about their shipments. Such monitoring systems may be adapted to track shipments being shipped within a country, shipments being exported from a country or shipments being imported into a country. The ultimate goal would be to integrate these various systems into one worldwide shipment tracking system. This could be accomplished by interfacing with networks from a variety of locations around the world. In the case of BAX Global Inc., each of these networks used their own computer systems which allowed them to view and manipulate data relating to individual shipments and manage their day-to-day operations. However, these computer systems did not use common software between the various business units, and this made sharing data between the business units difficult. The types of data gathered in each of these systems were not common between the computer systems, and the standards for the quality of that data was also not common between them. Replacing the existing variety of data entry systems with a single worldwide piece of software was difficult, as the various data entry systems provided a great deal of value for the local business units, including financial functions and governmental regulatory functions which would be difficult and expensive to replicate in a single piece of software.

To overcome these problems required a combination of software, databases and communications connections that allowed the near-real-time transfer of data from a variety of data entry systems into a single database. Creating processes to standardize the system's procedures and compliance reporting ensures that the core data elements needed to manage operations on a day-to-day, worldwide basis are available to the system's employees and its agents, and that the data elements needed for shipment tracking and reporting functions are available to the customers. The database and software have been designed to be scalable to meet the changing demand of the company or its customers in allowing additional data elements to be added to the system without the need for additional system development.

### SUMMARY OF THE INVENTION

It is an object of this invention to provide a new and improved system for inputting shipment data indicative of the attributes of a plurality of shipments as each shipment moves through a shipment-cycle and/or at least one event occurring to each shipment during its shipment-cycle.

It is another object of this invention to provide a new and improved system for accessing data from a plurality of terminals, determining for each shipment a set of core data elements and determining whether shipment data has been entered in each core data element of each shipment.

It is still a further object of this invention to provide a new and improved system for gathering data comprising a plurality of disparate shipment data input terminals for entering shipment data into the system, wherein at least one of shipmen data input terminals includes a computer programmed to operate synchronously and another shipment data input terminal includes a computer programmed to operate asynchronously.

It is another object of this invention to provide a new and improved system for facilitating each of a plurality of customers to enter it criteria to search for certain attributes of the shipment data, to construct based on the entered criteria a request for the shipment data of at least one of the customer's shipments and to search shipment data stored a warehouse data base for shipments with attributes that match the customer's search criteria.

In accordance with these and other objects of this invention, there is disclosed a method for determining compliance statistics from data that is indicative of the attributes of a plurality of shipments as each of the plurality of shipments moves through a shipment-cycle from a first station to a second station of a plurality of the stations. The shipment data reflects the attributes of each shipment and/or at least one event occurring to each shipment during its shipment-cycle. The compliance determining method comprises the steps of assigning at least one terminal to selected of the plurality of stations and entering shipment data from each of the plurality of terminals to a central computer. Next, the method accesses from the shipment data entered into the central computer core data elements that are used to determine the compliance statistics and that comprise a subset of the shipment data entered by the plurality of terminals into the central computer. Next, the method determines which of the core data elements that are/is associated with each of the plurality of shipments and then, determines whether shipment data has been entered in each core data element of each shipment.

In a further aspect of this invention, the system for collecting and monitoring shipment data involves one or more system administrators who enters into the system shipment data that is indicative of the status of a plurality of shipments as at least one shipment is moved through a shipment-cycle. The shipment data reflects the attributes of each shipment and/or events occurring to each shipment during its shipment-cycle. The collecting and monitoring system comprises a first plurality of synchronous terminals, each of the plurality of synchronous terminals comprises a browser and an emulator, and a second plurality of non-synchronous terminals, each of the plurality of non-synchronous terminals comprises at least one data input system and a non-synchronous terminal memory. Each of the first and second data transmission networks transmits there over the shipment data from one of the terminals. A central computer comprises a shipment tracking database for receiving and storing shipment data therein, and a shipment tracking program memory for storing a program for receiving and storing shipment data in the shipment tracking database. A web server comprises a webpage memory for storing web pages for facilitating the service provider's entry of shipment data into the shipment tracking database. The emulator is actuated by at least one of the service providers to execute the program stored in the shipment tracking program memory to connect the emulator to the central computer by the first data transmission network to enter shipment data into the shipment tracking database. The browser is actuated by the one service provider to connect the browser by the second data transmission network to the webpage memory, whereby the service provider may display at least one webpage to facilitate the one service provider to enter shipment data over the second data network to the shipment tracking database. Each of the data input systems is non-synchronous with respect to each of the web server and the central computer, whereby shipment data is inputted from the data input system into the shipment tracking database by the first transmission data network.

In a still further aspect of this invention, a system is disclosed for collecting and monitoring shipment data, wherein one or more service providers can enter into the system shipment data that is indicative of the attributes of a plurality of customer shipments as one or more customers forwards at least one customer shipment through a shipment-cycle. The shipment data reflects the attributes of each customer shipment and/or events occurring to at least one customer shipment during its shipment-cycle. The collecting and monitoring system comprises a plurality of customer terminals, each customer terminal comprising a customer display, a customer computer and a customer data input device, the customer computer being programmed to facilitate the customer to input using its data input device a request for the shipment data of one or more of the customer's shipments. The collecting and monitoring system further comprises a web server comprising a server memory for storing web pages for facilitating at least one customer to enter a request for shipment data, and a central computer which comprises a shipment tracking data base for receiving and storing shipment data. The central computer is programmed for receiving and storing shipment data in the shipment tracking data base. There is further included a plurality of disparate shipment data input terminals for entering shipment data into the system, at least one of the plurality of shipment data input terminals has a synchronous terminal computer which is programmed to operate synchronously with respect to the web server and the central computer, and at least another of the plurality of shipment data input terminals has a shipment data input memory and an asynchronous terminal computer which is programmed to operate asynchronously with respect to the web server and the central computer to determine whether the inputted shipment data represents a change in the attribute and/or the status of the customer shipment. If the inputted shipment data represents the attributes, the received shipment data is stored in the shipment data input memory and the inputted shipment data from the shipment data input memory is downloaded to the shipment tracking data base.

In a further aspect of this invention, there is disclosed a system for collecting and entering shipment status data into the system. The shipment status data is indicative of the status of at least one customer shipment which one or more customers forwards through a shipment-cycle. The shipment status data reflects selected events occurring to at least one shipment during its shipment-cycle. The collecting and entering system comprises a central computer comprising a shipment tracking database for receiving and storing the shipment status data, the central computer being programmed to receive and store shipment status data into the shipment tracking data base, and a data input for assigning a status code to identify the physical position where each of the selected events occurs and for transmitting in real time via a data transmission network the shipment status data and the assigned status codes to the shipment tracking database. Each of a plurality of customer terminals comprises a customer display, a customer computer and a customer data input device. The customer computer is programmed to facilitate the one customer to input using its data input device at least one request for the shipment status data of the one customer's shipment(s). Finally, the data collecting and entering shipment system is comprised of a web server, which in turn includes a server memory for storing web pages for facilitating the one customer to enter a shipment status data request for the shipment status data of the one shipment of the one customer.

In a still further aspect of this invention, a system is provided for collecting and entering shipment data into the system, wherein the shipment data is indicative of the confidential attributes of each of the plurality of shipments, and each of the plurality of shipments is forwarded by a related customer. The collecting and entering system comprises a web server, a plurality of customer terminals and a data warehouse. The web server comprises a web page memory for storing web pages for facilitating each of the plurality of customers to enter a request for the shipment data of at least one of the customer's shipments. Each of a plurality of customer terminals comprises a customer display, a customer computer and a customer data input device. The data warehouse computer comprises a warehouse database for receiving and storing the shipment data, and is programmed to respond to the receipt of the request for the shipment data by prompting the one customer to input its password, to compare the one customer's pass word with a plurality of valid customer passwords, if there is a match, prompting the one customer to enter its search criteria, and to construct and apply a search request for the entered search criteria to search the shipment data stored in the warehouse data base to provide a list of one or more shipments with attributes that match the customer's search criteria.

### BRIEF DESCRIPTION OF THE DRAWINGS

For a better understanding of the invention and further features thereof, reference is made to the following detailed description of the invention to be read in conjunction with the accompanying drawings, wherein:

FIG. 1 is a functional block diagram of a system for entering shipment data from a plurality of systems and transmitting it to a centrally disposed processor, where it is processed for compliance reporting and shipment tracking;

FIG. 2 is a flow diagram of a method for entering data directly into the tracking database from each of the plurality of terminals via terminal emulation;

FIGS. 3A-C are example screens from mainframe programs downloaded from the central processor to each of the plurality of terminals as described in the process of FIG. 2;

FIG. 4 is a flow diagram of a further process for entering data from the plurality of terminals to the central processor via the internet;

FIGS. 5A-D are a plurality of example screens which are downloaded as web pages from the central processor and display data that is processed by the process of FIG. 4;

FIG. 6 is a flow diagram illustrating a further process for data entry from an asynchronous data entry system terminal;

FIG. 7 is a flow diagram of the process of monitoring the data entry from the plurality of terminals to determine whether there is a complete set of core data elements for shipments that match the user's online search criteria.

FIGS. 8A-B are a plurality of example screens which are displayed via terminal emulation from the mainframe computer when displaying data by the process of FIG. 7.

FIG. 9A-C is a flow diagram of the process of extracting shipment data from the mainframe computer to the data warehouse computer in order to create a shipment history database, analyzing compliance statistics to determine whether there is a complete set of core data elements for each of the shipped shipments, creating compliance reports based on those statistics, and maps illustrating an example of the stations employed for tracking shipments as they are shipped from an origin station to a destination station;

FIG. 10 is a flow diagram of the process of requesting the compliance statistics of the entry of the core data elements for a station, a country and a region;

FIGS. 11A-D are screens downloaded as web pages from the central processor computer and displaying the data as generated by the flow diagram of FIG. 10;

FIG. 12 is a flow diagram representing the process by which a customer can access real-time shipment tracking data in the shipment tracking database associated with the central processor;

FIGS. 13A-F are screens downloaded from the central processor in the form of web pages for providing to a particular customer fields for entering its search criteria for the shipment data of interest to a particular customer, and for displaying the requested customer data that was generated by the process implemented by the flow diagram as shown in FIG. 12.

FIG. 14 is a flow diagram representing the process by which a customer can access reporting data from the shipment history database in the data warehouse computer.

FIGS. 15A-B are screens downloaded from the central processor in the form of web pages for providing to a particular customer fields for entering its search criteria for the reporting data of interest to a particular customer, and for returning the requested customer data that was generated by the process implemented by the flow diagram as shown in FIG. 14.

### DETAILED DESCRIPTION OF A PREFERRED EMBODIMENT OF THE INVENTION

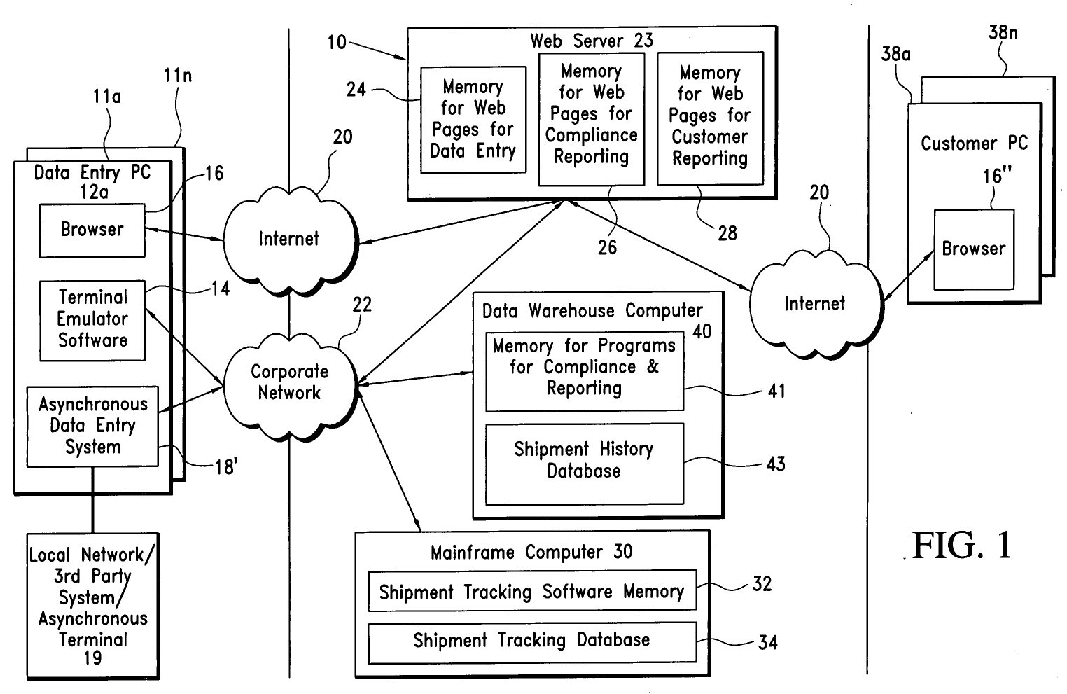

Referring now to the drawings and in particular to FIG. 1, there is shown an illustrative embodiment of a shipment tracking system 10 for implementing at least three functions as will be explained below in detail.

In the first function, the shipment tracking system 10 allows system employees or agents to enter data concerning the movement of shipments between the points of receipt and delivery via a choice of three separate methods, thereby providing an ease of data entry and access to the full range of required data elements. This is facilitated by the locations of a plurality of stations 11a-n. Illustratively, each station 11a-n is a place through which shipments move in a shipment cycle from the first station 11a, which picks a shipment up from a shipper, or to which the shipper may bring the shipment, to the last station 11n, which delivers the shipment to the consignee, or to which the consignee may go to receive the shipment. It is understood that in an illustrative embodiment of this invention the plurality of stations 11a-n are located throughout the countries and regions of the world. As will be described in detail below, there are three methods of performing this first function of entering shipment data by system employees or agents: via mainframe terminal emulation, via a data network which in an illustrative embodiment of this invention, takes the form of the internet 20, or via a data transmission from an asynchronous data entry system 18, such as a 3^{rd} party vendor. The first two methods employ real-time data entry, and the third uses a data process that makes the transmitted data available to system employees and customers no later than 20 minutes after the transmission was received, thereby qualifying for the term “near-real-time”.

In the second function, the shipment tracking system 10 maintains and responds to a system employee's or agent's request for reports on the employee's or agent's location's compliance to the data standards set by a system administrator for the shipment tracking system 10. As will be described below, there are two methods of performing this second function of providing compliance reports: one for real-time operations and one for statistical reports.

In the third function, the shipment tracking system 10 responds to a customer's request for data concerning shipments that they were shipping or shipments which were addressed to them. As will be described in detail below, there are a variety of methods of performing this third function of responding to a customer request for shipment data. We will use two example methods to illustrate this function; one for real-time data retrieval and one for historical data retrieval.

Still referring to FIG. 1, the first method of performing the first function, i.e., to enter data concerning the shipments via mainframe terminal emulation, is as follows. Each of the plurality of stations 11a-n has a corresponding one of the computer terminals 12a-n, which may illustratively take the form of a personal computer (PC) and may include a terminal emulator software 14 which may illustratively take the form of a Rhumba as sold by Wall Data Inc., a Reflections as sold by WRQ Inc., or a DO3270 as sold by Dynacomm. A system employee or agent may actuate a computer terminal 12 at one of the stations 11 to execute the terminal emulator software 14. Terminal emulator software 14 allows the system employee or agent to connect their computer terminal 12 to a mainframe computer 30 via a synchronous communication link, which in one illustrative embodiment of this invention may take the form of a corporate network 22. The internet 20 is an open network which anyone can access, whereas the corporate network 22 is only available to users authorized by the corporation or administrator of the shipment tracking system 10. The emulator 16 is a device that is designed to behave like another device. In this embodiment, the emulator 14 is programmed to enable a PC to behave like a terminal for the mainframe computer 30. The mainframe computer 30 comprises in one illustrative embodiment of this invention a memory 32 for storing shipment tracking software, and a shipment tracking database 34, for the storage of shipment data. Shipment data in the context of this document encompasses the totality of data regarding a specific shipment that is entered, captured or created during the shipment-cycle. This would include physical details (size, weight, location, etc.), customer details (shipper info, consignee info, rate and charge information, etc.) and movement details (ID of container into which the shipment was loaded, ID of plane into which the container was placed, etc.). The system employee accesses the software for data entry, stored in the shipment tracking software memory 32 and enters the shipment data. The shipment tracking software as stored in the memory 32 stores all of the entered data in real-time in the shipment tracking database 34 in a manner as will be explained in detail below.

Still referring to FIG. 1, the second method of performing the first function, i.e., to enter data concerning the shipments via the internet 20, is as follows. Each of the plurality of stations 11a-n has a corresponding one of the computer terminals 12a-n, which may illustratively take the form of a personal computer (PC) and may include browser software 16 which may illustratively take the form of an Internet Explorer as sold by Microsoft Corp. or a Netscape Navigator as sold by Netscape Communications Corp. A system employee may actuate one of the computer terminals 12a-n at one of the stations 11a-n to execute the browser software 16. The browser 16 allows the system employee to connect their computer terminal 12 to a web server 23 via a synchronous communication link, which in one illustrative embodiment of this invention may take the form of the internet 20. In an illustrative embodiment of this invention, the web server 23 comprises a memory 24 for storing web pages shown below that facilitates data entry, a memory 26 for storing web pages shown below that facilitate maintaining a system compliance standard for the shipment data entered into the system 10, and a memory 28 for storing web pages shown below that facilitate the customer's shipment tracking and reporting as will be described below. The system employee accesses the web pages for data entry from its memory 24 and enters the shipment data. The web server 23 sends that data via the corporate network 22 to the mainframe computer 30, which executes the shipment tracking software as stored in the memory 32 to store all of the entered shipment data in real-time in the shipment tracking database 34 in a manner as will be explained in detail below.

Still referring to FIG. 1, the third method of performing the first function, i.e., to enter data concerning the shipments via a transmission from an asynchronous data entry system 18, is as follows. In both of the two methods described above, the connection to the mainframe computer 30 is synchronous, meaning that it occurs in real time and data is processed immediately upon entry. Synchronous indicates actions taking place in an immediate sequence, between which there is no discernable time interval. As stated above, the data is processed immediately upon entry. Asynchronous, by extension, indicates actions that take place in sequences independent of each other, and between which there can be a discernible time interval. Thus the asynchronous data entry system 18 does not immediately transfer data to the mainframe computer 30, whereas the synchronous emulator 14 and browser 16 transmit immediately data to the mainframe computer 30 in real time. This third method provides for the transmission of shipment data from an asynchronous data entry system 18 which resides on a local system network 19. Each of the plurality of stations 11a-n has a corresponding one of the plurality of computer terminals 12a-n which may illustratively take the form of a personal computer (PC) and may include the data entry system 18 running on a local network 19. This local network 19 may be a third party system, or an asynchronous terminal system that is not supported by a service provider, or one that is distributed by the service provider to system employees or agents who do not have access to the real-time methods of entry. The Service Provider is the entity with which a customer contracts for the delivery of their shipment. The Service Provider is also responsible for the management of the system 10 being described in this application. A system employee, agent or 3^{rd} party may use the data entry system 18 of the corresponding computer terminal 12 to enter the shipment data. All of the entered shipment data is then stored in a memory (not shown) in the data entry system 18. The data entry system 18 then opens a connection via the corporate network 22 from the corresponding computer terminal 12 to the mainframe computer 30 and transmits the shipment data from the data entry system 18 to the mainframe computer 30. In turn, the mainframe computer 30 executes the shipment tracking software stored in the memory 32 to process the transferred shipment data, i.e., to copy the data elements from the transferred shipment data and to store these elements in the shipment tracking database 34. The timing of these transmissions and the software that processes the data is set so that the data appears in the shipment tracking database 34 within a relatively short period of time of the transmission, e.g., 20 minutes, and can then be accessed by system employees or customers, making this a “near-real-time” method.

Still referring to FIG. 1, the first method of performing the second function, i.e., that of system compliance in an operational mode, is as follows. The system employee access the mainframe computer 30 via the terminal emulator 14 and executes a compliance request screen. The system employee then enters criteria about the shipments that they want information on. The search criteria is validated by compliance programs in the shipment tracking software memory 32. The compliance programs then identify the shipments that match the system employee's criteria, and compare the shipment data entered for those shipments against the list of core data elements. The system 10 then displays a listing of the shipments and a listing of the data elements that those shipments are missing. The system employee can then use any of the previously discussed entry methods to enter the missing data and bring the shipment data into compliance. This process helps to ensure that each of the core data elements is consistently entered for each shipment processed by the system 10.

Still referring to FIG. 1, the second method of performing the second function, i.e., that of system compliance in reporting mode, is as follows. Each night, a program in the shipment tracking software memory 32 copies all of the data entered during a previous time interval, e.g., 24 hours. Once that copy of data is complete, then the data warehouse computer 40 opens the corporate network 22 to the mainframe computer 30. The copied shipment data is then transferred from the mainframe computer 30 to the data warehouse computer 40. The data warehouse computer 40 then executes programs stored in it's memory 41 for compliance and reporting that append the new data to the existing historical data in the shipment history database 43. This appended data for each shipment is then compared to a core data element listing to determine which of the core data elements have been entered and which ones have not been entered. The totals of this comparison are then summarized by station, country and region and those summaries are stored in data files. The data warehouse 40 then opens the corporate network 22 to the web server 23 and transfers those summarized data files to the memory 26 for web pages for compliance reporting where they are available for viewing by system employees.

System employees at each of the stations 11a-n can monitor the compliance of their station 11, country, or region with the system administrator's data entry standards. In particular, a system employee will actuate one of the computer terminals 12 to call up and execute a piece of browser software 16, which allows the system employee to connect their computer terminal 12 to the web server 23 via the internet 20. The system employee then employs his/her browser 16 to access particular web pages from the memory 26 which stores the web pages that facilitates compliance reporting and requests the compliance data for a region, a country, or a particular station within a region or country. The web server 23 sends that request to the memory 26 for web pages for compliance reporting which processes the system employee's request and sends the compliance statistics requested back to the web server 23. The web server 23 then formats the compliance statistics into a compliance reporting web page that is stored in the memory 26 and sends that web page through the internet 20 to the browser 16 from the station 11 from which the request was sent, whereby the system employee at the requesting station 11 can view the web page containing their compliance statistics. This process helps to ensure that each of the core data elements is consistently entered for each shipment processed by the system 10.

Still referring to FIG. 1, the first method of performing the third function, i.e., that of responding to a customer request for real-time tracking data from the shipment tracking database 34, is as follows. As the shipment-cycle of the shipment moves from receipt of a parcel to its delivery, additional shipment data is obtained and entered into the system 10 in one of the three methods described above. As the information regarding a shipment changes, that change is recorded with a date and time stamp that identifies the time and date of the change. A particular milestone or status code can be associated with the shipment at many points in the shipment process. Shipment milestones are identified and recorded by the system 10 as will be described in detail below. Status Codes (or Milestone Codes) are used to indicate a specific event that has occurred to a shipment during the shipment-cycle. For example, when a shipment is delivered a milestone/status code of “DL” is entered to record the delivery.

The data required for report requests can vary from customer to customer, and the manner in which a customer receives their report data can also be highly specific to the customer. Many specialized processes have been instituted in order to fulfill a specific customer reporting request as would be recognized by one skilled in the art. The following description is a generic approach that is employed by many customers and is presented here as an illustrative method.

Shipment data is the complete range of data we collect regarding the shipment. Tracking data is a sub-set of Shipment data and specifically refers to milestone/status codes and the data associated with those codes, like time and date, location, etc. To request tracking data, a customer will employ one of a plurality of customer terminals 38a-38n to call up a piece of the software stored in a browser 16″ of one of the customer terminals 38. The browser 16″ executes this software to facilitate the customer to connect their customer terminal 38 to the web server 23 via the internet 20. The customer then accesses memory 28 for the web pages for customer reporting and requests tracking data for a specific shipment or shipments. The web server 23 sends that request through the corporate network 22 to the shipment tracking software memory 32. The mainframe computer 30 executes the shipment tracking software accessed from the memory 32 to process the request and to send the history of milestones for that shipment or shipments back through the corporate network 22 to the web server 23. The web server 23 then formats the tracking data into a customer reporting web page and sends that web page through the internet 20 to the browser 16″ of the corresponding one of the customer's terminals 38a-38n, whereby the customer can view the web page containing their tracking data.

Still referring to FIG. 1, the second method of performing the third function, i.e., that of responding to a customer request for historical data from the shipment history database 43, is as follows. As described previously and as will be described in detail below, every 24 hours all shipment data is copied from the mainframe computer 30 to the data warehouse computer 40 and appended to the existing historical shipment data. The total sum of the historical data for each shipment is then available for extraction based on the customer's requirements.

The data required for report requests can vary from customer to customer, and the manner in which a customer receives their report data can also be highly specific to the customer. Many specialized processes have been instituted in order to fulfill a specific customer reporting request as recognized by one skilled in the art. The following description is a generic approach that is employed by many customers and is presented here as an illustrative method.

To request reporting shipment data, a customer will employ one of the plurality of customer terminals 38a-38n to call up a piece of the software stored in a browser 16″ of one of the customer terminals 38. The browser 16″ executes this software to facilitate the customer to connect their customer terminal 38 to the web server 23 via the internet 20. The customer then accesses the memory 28 for the web pages for customer reporting and requests reporting data. The web server 23 sends that request through the corporate network 22 to the data warehouse computer 40. The data warehouse computer 40 executes the shipment reporting software accessed from the memory 41 to process the request and to send the reporting data for that customer back through the corporate network 22 to the web server 23. The web server 23 then formats the data into a customer reporting web page and sends that web page through the internet 20 to the browser 16″ of the corresponding one of the customer's terminals 38a-38n, whereby the customer can view the web page containing their reporting shipment data.

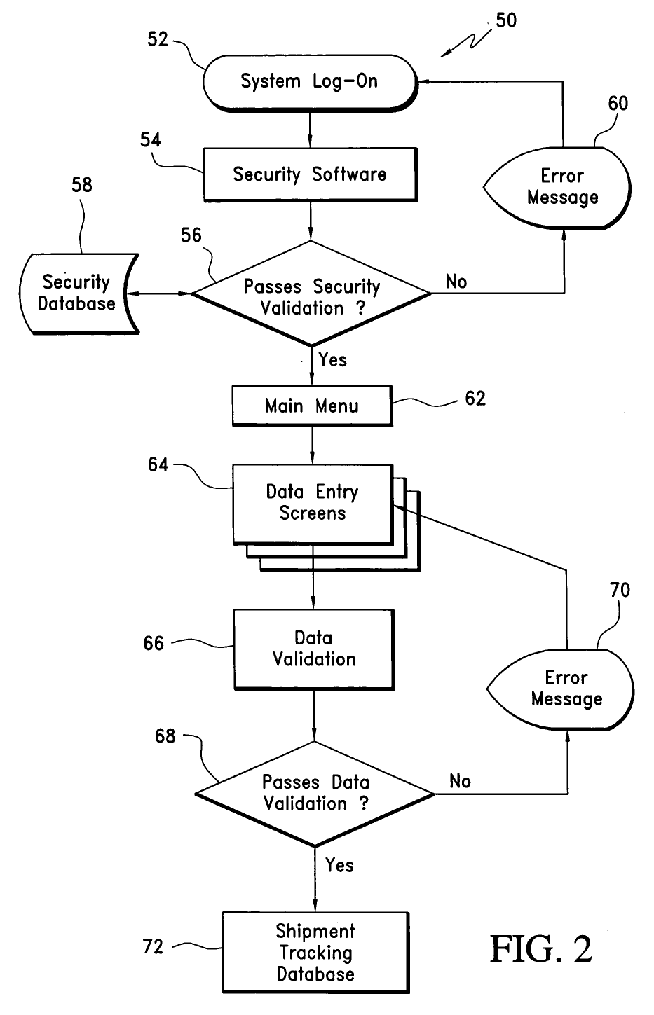

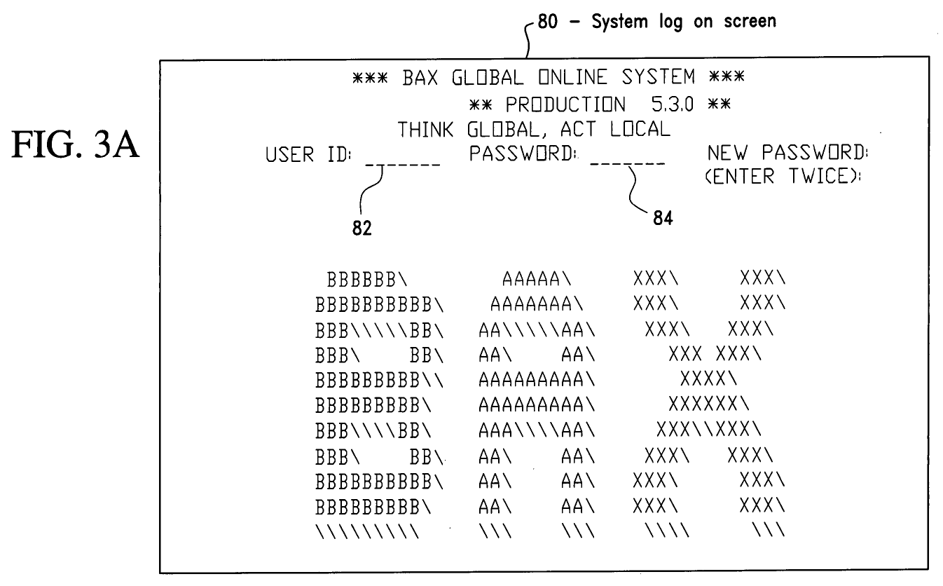

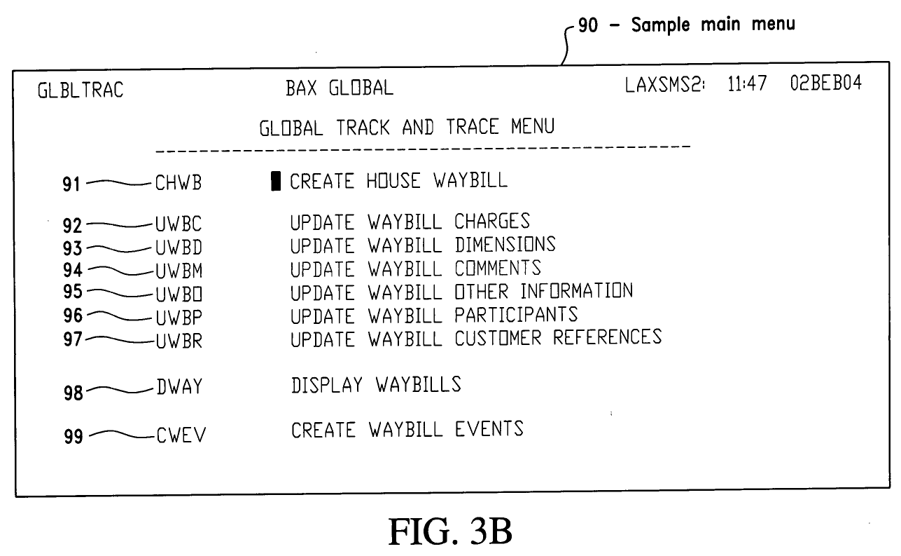

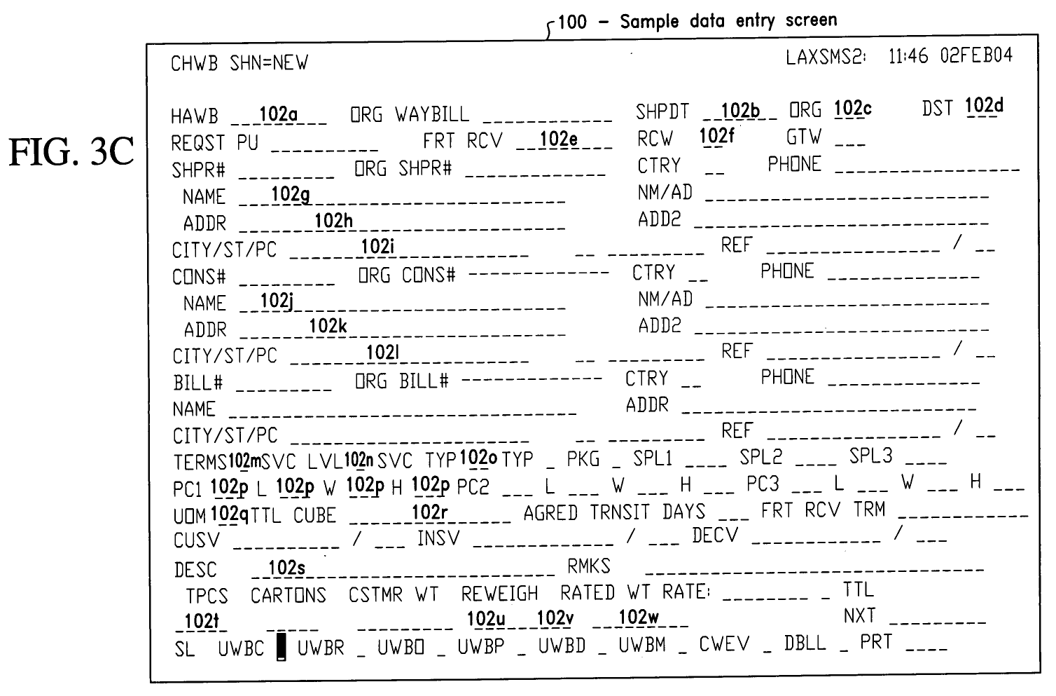

Referring now to the flow chart of FIG. 2, a method 50 is shown for accessing and entry of shipment data directly into the shipment tracking database 34 as shown in FIG. 1, whereby a system employee calls up a piece of terminal emulator software 14 and initiates a connection through the corporate network 22 to the mainframe computer 30. When the connection is made, the system employee in step 52 is shown a system log-on screen 80 as shown in FIG. 3A, whereby the system employee is prompted to enter their unique user ID in data entry field 82 and their password in data entry field 84. In step 54, the system employee's entries are passed to the security software for validation. In step 56, the entered system employee's ID and password are compared with the authorized system employees or agents' IDs and passwords as stored in a security database 58 and, if there is a match, access to the system 10 is granted. If there is no match as determined in step 56, access is not granted, the system displays an error message in step 60, and the system employee is returned to step 52 where the system log-on screen 80 is again displayed.

Once access is granted in step 56, then a main menu 90 for the system 10 displays in step 62 as shown in FIG. 3B. From the main menu, the system employee can then navigate to one of the plurality of data entry screens by which the system employee can enter different kinds of shipment data. Each data entry screen in the mainframe is identified with a specific 4-letter designation, which the memory 32 containing the shipment tracking software uses to identify what software to execute to generate the screen and a title which are displayed at a corresponding one of a plurality of data entry screens 91-99 (FIG. 3B), examples of which are defined as follows.

| | Transaction | | |
|---|---|---|---|
| Screens | ID | Transaction Title | Transaction Description |
| 91 | CHWB | Create House Waybill | Used to create, update, and delete waybills. |
| 92 | UWBC | Update Waybill | Used to update and delete charges on |
| | | Charges | waybills. |
| 93 | UWBD | Update Waybill Dims | Used to update and delete dimensional |
| | | | information on waybills. |
| 94 | DWBM | Display Waybill | Used to update and delete comments on |
| | | Comments | waybills. |
| 95 | UWBO | Update Waybill Other | Used to update and delete remarks and |
| | | Information | descriptions on waybills. |
| 96 | UWBP | Update Waybill | Used to update and delete participants on |
| | | Participants | waybills. |
| 97 | UWBR | Update Waybill | Used to update and delete customer references |
| | | References | on waybills. |
| 98 | DWAY | Display Waybill | Used to display a summary listing of all |
| | | | waybills that match the user's search criteria. |
| 99 | CWEV | Create Waybill Events | Used to add, update, and delete events on |
| | | | waybills. |

Please note that the screens discussed above are only meant to be illustrative embodiments of this invention. Different screen choices may appear for different system employees or agents, based on their location. These alternate screens contain most of the same data elements as the screens discussed above, but the layout of those elements may be altered to match the source documents that the system employee is using to perform the data entry. Further, there are additional screens for the entry of data concerning the Master Air Waybill and the entry of data concerning the delivery of shipments. These screens are similar to the ones discussed above, in that they contain data fields for the entry of shipment data, and the choice of screens available to a system employee will be dependant upon the location of that employee.

Once the system employee makes a selection from the main menu 90 in step 62, the selected one of the data entry screens 91-99 they have selected is displayed in step 64. For the purpose of explanation, we will assume that the system employee has selected a screen 100 labeled CHWB Create House Waybill, as shown in FIG. 3C. The system employee will enter as many of the data fields on the screen 100 as possible, with particular attention paid to the data fields where the system employee is expected to enter core data elements in a plurality of fields 102a through 102w on the selected screen 100, as well as entering data that is not considered “core data”.

The core data elements are specific elements of the shipment data which are required for every shipment in order to meet the system administrator's requirements for compliance and the customer's and company's requirements for tracking and reporting. These attributes are in one illustrative embodiment of this invention set by an administrator of the shipment tracking system 10. There are a plurality of discrete data elements that can potentially be entered for any specific shipment. They relate to many aspects of the shipment, for example the shipper, the consignee, the weight of the shipment, the route, the method used to transport the shipment, etc. Not all data elements apply to all shipments, so the system administrator has identified a scalable sub-set of all the possible data elements as “core data” that must be entered for every shipment, and the shipment tracking system 10 supplies three methods, of which this is the first, by which system employees or agents can enter the core data. The system administrator can add or remove data elements from this sub-set as needed, and the shipment tracking software 32 is designed to recognize these changes as they are made, without having to be re-programmed. This allows for a flexibility in defining required data that must meet compliance standards and/or must be available for customer reporting.

A single station 11 (and its terminal) is not responsible for entry of all of the core data elements for a single shipment. The responsibility for entering core data is assigned based on the origin and destination stations 11 identified on the HAWB and MAWB for the shipment. “HAWB” is an acronym for “House Air WayBill”, and the HAWB is the receipt issued to the customer by the system administrator. It documents, among other things, the address where the shipment was picked up, the name of the shipper, and the station 11, known as the HAWB origin, which received the picked up shipment. The receipt also documents the address where the shipment is to be finally delivered, the name of the consignee, and the station, known as the HAWB destination, from which the delivery will be made. MAWB is an acronym for “Master Air WayBill”, and the MAWB is the receipt issued by the system administrator to the freight carrier which has been contracted to move a consolidation of shipments from one central station 11, known as the MAWB origin, to another central station 11, known as the MAWB destination, where the consolidated shipments are returned to the system administrator for de-consolidation and further movements that will take the shipments to their HAWB destinations in preparation for final delivery. The role that a station 11 plays in the shipment-cycle of a shipment determines which core data elements the station 11 is responsible for entering into the system 10.

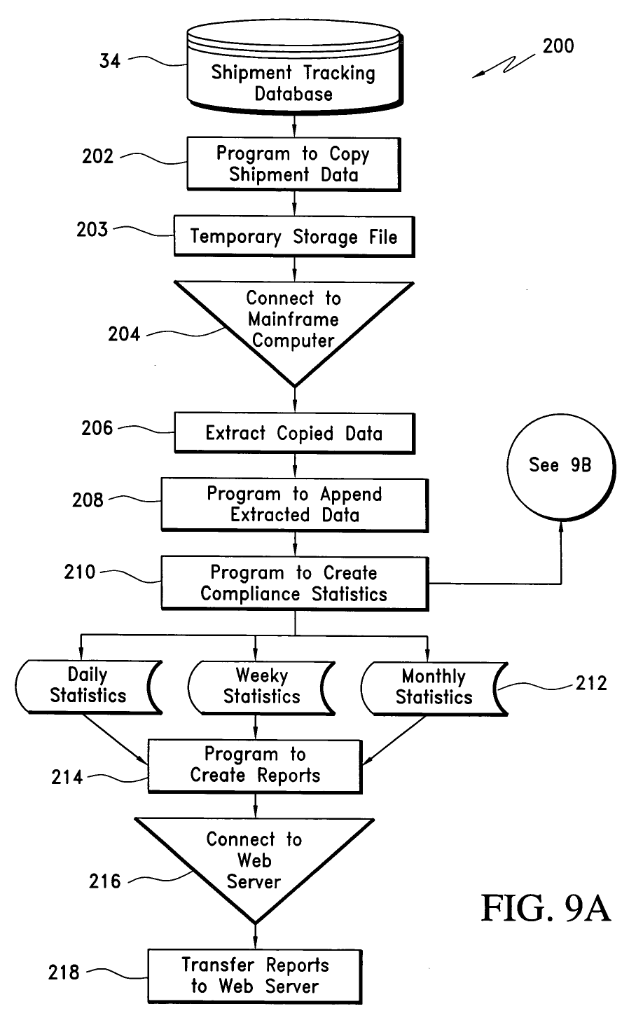

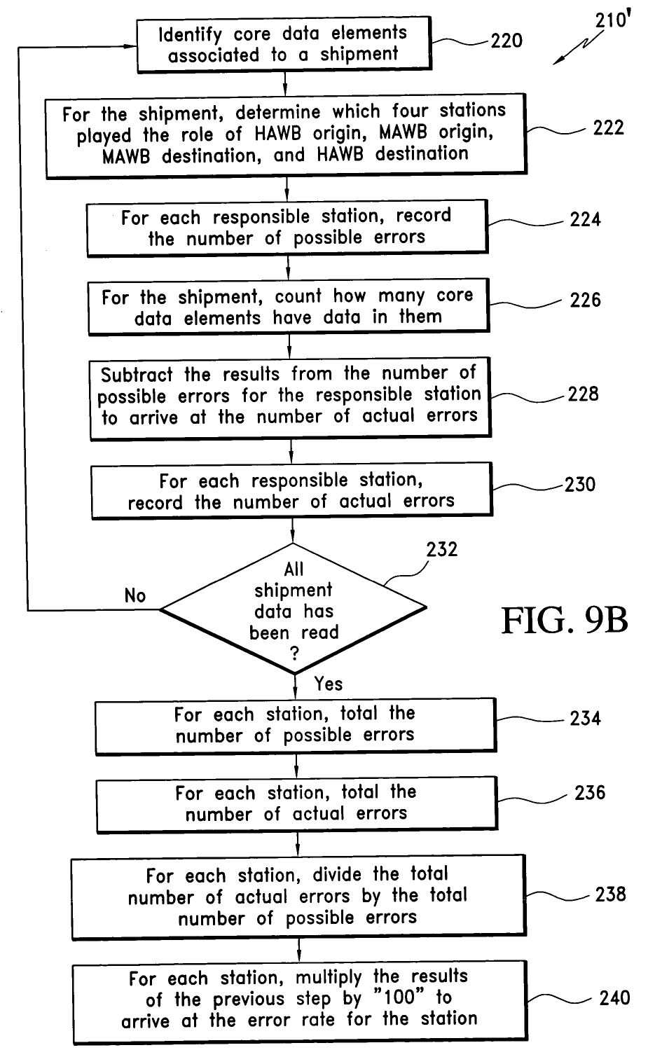

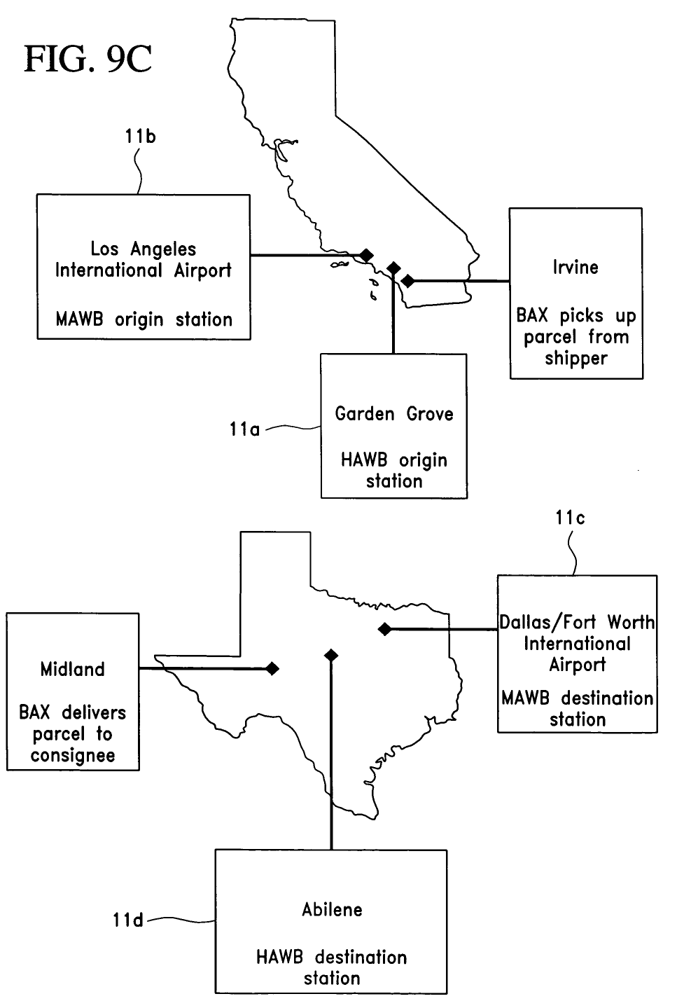

In an illustrative example of a shipment method from Irvine California to Midland Tex., there are four roles that a station 11 might perform, as shown in FIG. 9C. A shipment is picked up from a customer in Irvine, Calif. and taken to the service provider's station 11a in Garden Grove, Calif. The Garden Grove station 11a is the HAWB origin station, and as such is responsible for entering a certain number of core data elements regarding the shipment. The Garden Grove station 11a then trucks the shipment to the station 11b at the Los Angeles International Airport where the shipment is consolidated with many other shipments and the consolidated freight is then given to American Airlines for movement to the Dallas/Fort Worth International Airport. The Los Angeles station 11b is the MAWB origin station, and as such is responsible for entering a certain number of core data elements regarding the shipment. Once the shipment has reached Dallas/Fort Worth, it is recovered by the station 11c at that airport. The Dallas/Fort Worth station 11c is the MAWB destination station, and as such is responsible for entering a certain number of core data elements regarding the shipment. The Dallas/Fort Worth station 11c then trucks the shipment to the station 11d in Abilene, Tex. The Abilene station 11d arranges for the final delivery of the shipment to the consignee. The Abilene station 11d is the HAWB destination station, and as such is responsible for entering a certain number of core data elements regarding the shipment.

Referring now to FIG. 3C, the plurality of core data element fields 102a-102w and the station responsible for their entry are defined as follows.

| | Data Element | | Responsible |
|---|---|---|---|
| Fields | Name | Description | Station |
| 102a | House Air Waybill | The number that identifies the shipment in Argus+ | HAWB origin |
| | (HAWB) number. | (BAX's data entry system). | |
| 102b | HAWB date. | The date when the shipment begins moving | HAWB origin |
| | | through the system. | |
| 102c | HAWB origin. | The three letter station code for the origin of the | HAWB origin |
| | | shipment. | |
| 102d | HAWB | The three letter station code for the destination of | HAWB origin |
| | destination, | the shipment. | |
| 102e | Freight received | The time-of-day/day-of-month the freight was | HAWB origin |
| | time and date. | received. | |
| 102f | Where freight | The two letter code which allows the user to | HAWB origin |
| | received. | identify where the freight was received. | |
| 102g | Shipper name. | The name of the shipper. | HAWB origin |
| 102h | Shipper address. | The address of the shipper. | HAWB origin |
| 102i | Shipper city. | The name of the city where the shipper is located. | HAWB origin |
| 102j | Consignee name. | The name of the consignee. | HAWB origin |
| 102k | Consignee address. | The address of the consignee. | HAWB origin |
| 102l | Consignee city. | The name of the city where the consignee is | HAWB origin |
| | | located. | |
| 102m | Payment terms. | The requested payment terms for the HAWB. | HAWB origin |
| 102n | Service level. | A code that indicates the level of service for the | HAWB origin |
| | | shipment. | |
| 102o | Service type. | The two letter code indicating the type of service | HAWB origin |
| | | for the waybill. | |
| 102p | Package size. | The number of packages that are a particular | HAWB origin |
| | | length, width and height. Multiple entries can be | |
| | | made to accommodate many different packages. | |
| 102q | Unit of measure. | Unit of measure for package dimensions. | HAWB origin |
| 102r | Cubic measure. | The combined total cubic volume of the shipment. | HAWB origin |
| 102s | Description. | The description of the goods shipped. | HAWB origin |
| 102t | HAWB total | The total number of pieces in this shipment. | HAWB origin |
| | pieces. | | |
| 102u | Actual weight. | The weight of this shipment, as determined by | HAWB origin |
| | | BAX. | |
| 102v | Weight indicator. | A code that indicates whether the weight is in | HAWB origin |
| | | pounds (L) or Kilograms (K). | |
| 102w | Chargeable weight. | The weight used to calculate the freight charges. | HAWB origin |

The following is a list of the core data elements which are not entered on the CHWB screen, but entered on others of the data entry screens discussed above:

| | | Responsible |
|---|---|---|
| Data Element Name | Description | Station |
| Currency Code | The code that identifies the currency used to rate | HAWB origin |
| | the HAWB and for any entered charges | |
| Prepaid Charges | Total charges that were prepaid | HAWB origin |
| Collect Charges | Total charges that are collect | HAWB origin |
| 3^{rd} Party Charges | Total charges due from 3^{rd} party | HAWB origin |
| Freight Charges | Total Freight charges | HAWB origin |
| MAWB (Master Bill of | Number that identifies the Master Waybill | MAWB origin |
| Lading) number | | |
| Carrier Code | Code that identifies the carrier to whom the | MAWB origin |
| | MAWB was tendered | |
| Mode | Mode of transportation | MAWB origin |
| Routing | Routing of the MAWB from origin to destination | MAWB origin |
| Confirmed on Board | Confirmation of departure of the flight leaving the | MAWB origin |
| Flight #1 | origin | |
| ETA Leg 1 | Estimated time of arrival of the flight arriving at | MAWB origin |
| | the first destination | |
| ATD Leg 1 | Actual Time of departure for the first leg of the | MAWB origin |
| | routing | |
| Close of MAWB | Date and time that MAWB was completed | MAWB origin |
| Documents Received | Date and time that complete and accurate | MAWB |
| | documents were received | destination |
| Assign HAWBs to | Date and times that HAWBs are attached to | MAWB origin |
| MAWB | MAWBs | |
| ATA at Destination | Date and time of actual arrival of flight at | MAWB |
| | destination | Destination |
| Arrival Notice | Date and time that the broker was notified of | HAWB |
| | freight arrival | Destination |
| Entry Filed | Date and time that the Customs Entry was filed | HAWB |
| | | Destination |
| Customs Released | Date and time of Customs clearance | HAWB |
| | | Destination |
| POD (Point Of Delivery) | Date and time that shipment was delivered or | HAWB |
| Date & Time | status was updated with a “final” code. | Destination |
| POD Signature | Signature provided by the consignee for the | HAWB |
| | receipt of the goods | Destination |

Please note that the core data elements listed above are dynamic and can be changed by the system administrator. The listing above is meant to be a representative sample of the kinds of data elements being defined as “core data”.

In step 66, all of the entered shipment data is sent to a validation program which ensures as will be described in detail below that the shipment data entered meets certain standards. If the data does not pass the validation in step 68, then an error message is returned in step 70 to the system employee and displayed on the data entry screen 100 (FIG. 3C). The system employee can then correct the error and re-process the data until no errors are found. If the shipment data is validated in step 68, then all of the entered data is written in step 72 into the shipment tracking database 34 as shown in FIG. 1.

The validation rules used in step 66 for all of the core data elements are as follows:

| Data Element Name | Validation Rules |
|---|---|
| House Air Waybill | Must be comprised of 9 digits. No letters or special |
| (HAWB) number. | characters are allowed. Entry is required. |
| HAWB date. | Must be in DDMMMYY format. Cannot be more than 90 |
| | days in the past, when compared to time of entry. Cannot |
| | be more than 30 days in the future when compared to time |
| | of entry. Entry is required. |
| HAWB origin. | Requested service level must be valid for the origin. Code |
| | must be valid against the Master table of station codes |
| | located in the Mainframe. Entry is required. |
| HAWB destination. | Requested service level must be valid for the destination. |
| | Code must be valid against the Master table of station codes |
| | located in the Mainframe. Entry is required. |
| Freight received time and | Time must be entered in 24 hour HHMM format. Date must |
| date. | be entered in DDMMM format. Date/time combination |
| | cannot be in the future when compared to the local time at |
| | the location where the entry is made. If this field is entered, |
| | the “Where Freight Received” field must also be entered. |
| Where freight received. | If this field is entered, the “Freight Received Time and |
| | Date” field must also be entered. Code must be valid |
| | against the Master table of freight received location codes |
| | located in the Mainframe. |
| Shipper name. | Entry is required. |
| Shipper address. | No validation |
| Shipper city. | No validation |
| Consignee name. | Entry is required. |
| Consignee address. | No validation |
| Consignee city. | No validation |
| Payment terms. | Code must be valid against the Master table of payment |
| | terms codes located in the Mainframe. Entry is required. |
| Service level. | Code must be valid against the Master table of service level |
| | codes located in the Mainframe. Entry is required. |
| Service type. | Code must be valid against the Master table of service type |
| | codes located in the Mainframe. |
| Package size. | Must be from 1 to 3 digits. All 3 elements of size (length, |
| | width, height) must be entered. Cannot be entered if “Cubic |
| | Measure” is entered. |
| Unit of measure. | Must be “IN” for inches or “CM” for centimeters. |
| Cubic measure. | Must be entered as up to 12 whole numbers. Cannot be |
| | entered if “Package Size” is entered. |
| Description. | No validation |
| HAWB total pieces. | Must be a whole number with no decimal places. Entry is |
| | required. |
| Actual weight. | For weights entered as kilograms, entries can be up to 6 |
| | digits and one decimal place. For weights entered as |
| | pounds, entries can be up to 6 digits. |
| Weight indicator. | Must be “K” for kilogram, or “L” for pounds. |
| Chargeable weight. | For weights entered as kilograms, entries can be up to 6 |
| | digits and one decimal place. For weights entered as |
| | pounds, entries can be up to 6 digits. |
| Currency Code | Must be valid against the Master Currency table located in |
| | the Mainframe. |
| Prepaid Charges | Must be whole numbers followed by no more than 2 |
| | decimal places. |
| Collect Charges | Must be whole numbers followed by no more than 2 |
| | decimal places. |
| 3^{rd} Party Charges | Must be whole numbers followed by no more than 2 |
| | decimal places. |
| Freight Charges | Must be whole numbers followed by no more than 2 |
| | decimal places. |
| MAWB (Master Bill of | For MAWBs with a mode of “AIR”, must be up to 9 digits. |
| Lading) Number | For MAWBs with a mode of “OCEAN”, must be up to 12 |
| | characters. |
| Carrier Code | Must be valid against the Master Carrier Code table located |
| | in the Mainframe. |
| Mode | Must be “AIR” or “OCEAN”. |
| Routing | Must contain at least one leg of routing information. |
| | Cannot contain more than 3 legs of routing information. |
| | The destination of legs 2 and 3 cannot be the same as the |
| | destination in leg 1. The destination of leg 1 must be the |
| | same as the origin of leg 2. The destination of leg 2 must be |
| | the same as the origin of leg 3. Destinations of any of the 3 |
| | legs cannot be the same as the origin code for the MAWB. |
| | The destination for the MAWB code must appear as the |
| | destination of one of the 3 legs of routing information. The |
| | origin of leg 1 must be the same as the origin of the |
| | MAWB. |
| Confirmed on Board | Must be entered in HHMM/DDMMM format with the time |
| Flight #1 | in 24 hour (military) time. The date entered cannot be more |
| | than 7 days earlier than the shipdate for the MAWB. |
| ETA Final Leg | Must be entered in HHMM/DDMMM format with the time |
| | in 24 hour (military) time. The date entered cannot be |
| | earlier than the shipdate for the MAWB. |
| ATD Leg 1 | Must be entered in HHMM/DDMMM format with the time |
| | in 24 hour (military) time. The date entered cannot be more |
| | than 7 days earlier than the shipdate for the MAWB. |
| Close of MAWB | System enters in HHMM/DDMMMYYYY format with the |
| | time in 24 hour (military) time when the user enters “CL” in |
| | the MAWB Status field.. |
| Documents Received | Must be entered in HHMM/DDMMM format with the time |
| | in 24 hour (military) time. Date/time combination cannot be |
| | in the future when compared to the local time at the location |
| | where the entry is made. |
| Assign HAWBs to | System enters in HHMM/DDMMMYYYY format with the |
| MAWB | time in 24 hour (military) time when the user assigns a |
| | HAWB to a MAWB. |
| ATA at Destination | Must be entered in HHMM/DDMMM format with the time |
| | in 24 hour (military) time. Date/time combination cannot be |
| | in the future when compared to the local time at the location |
| | where the entry is made. |
| Arrival Notice | Must be entered in HHMM/DDMMM format with the time |
| | in 24 hour (military) time. Date/time combination cannot be |
| | in the future when compared to the local time at the location |
| | where the entry is made. |
| Entry Filed | Must be entered in HHMM/DD format with the time in 24 |
| | hour (military) time. |
| Customs Released | Must be entered in HHMM/DD format with the time in 24 |
| | hour (military) time. |
| POD (Point Of Delivery) | Must be entered in HHMM/DD format with the time in 24 |
| Date & Time | hour (military) time. |
| POD Signature | Entry is required. |

Please note that the validation rules listed above are dynamic and can be changed by the system administrator. The listing above is meant only to be an illustrative embodiment of the types of validation being performed.

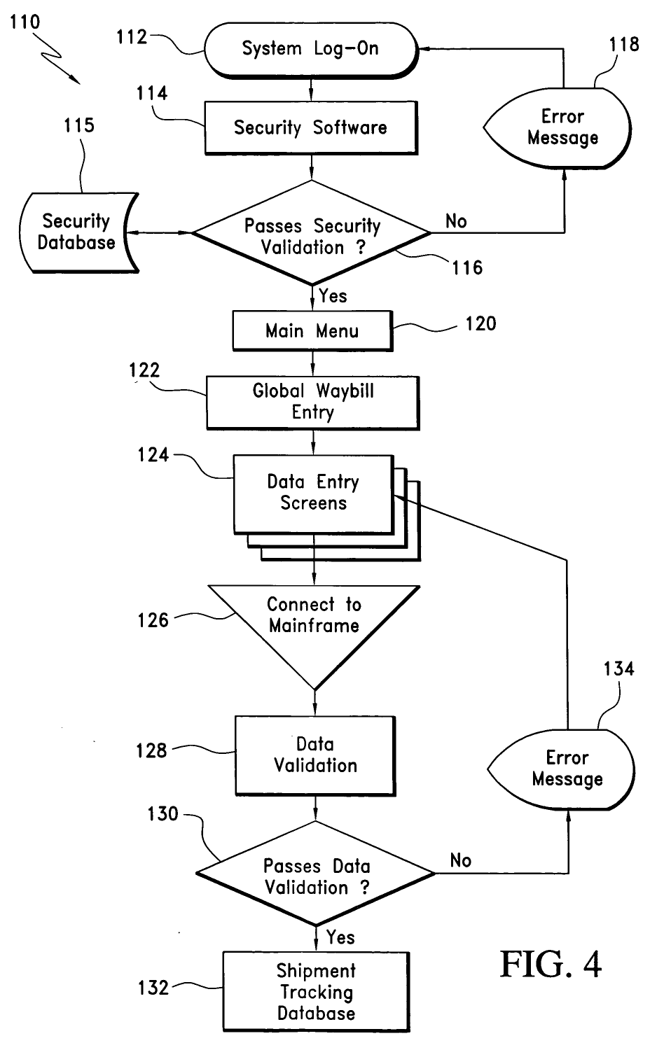

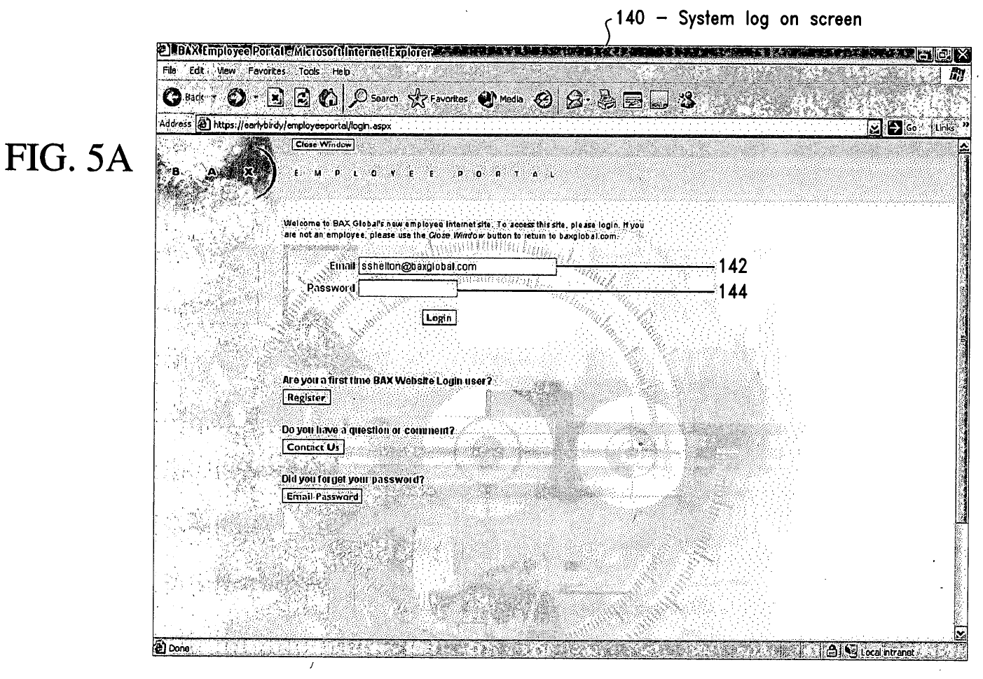

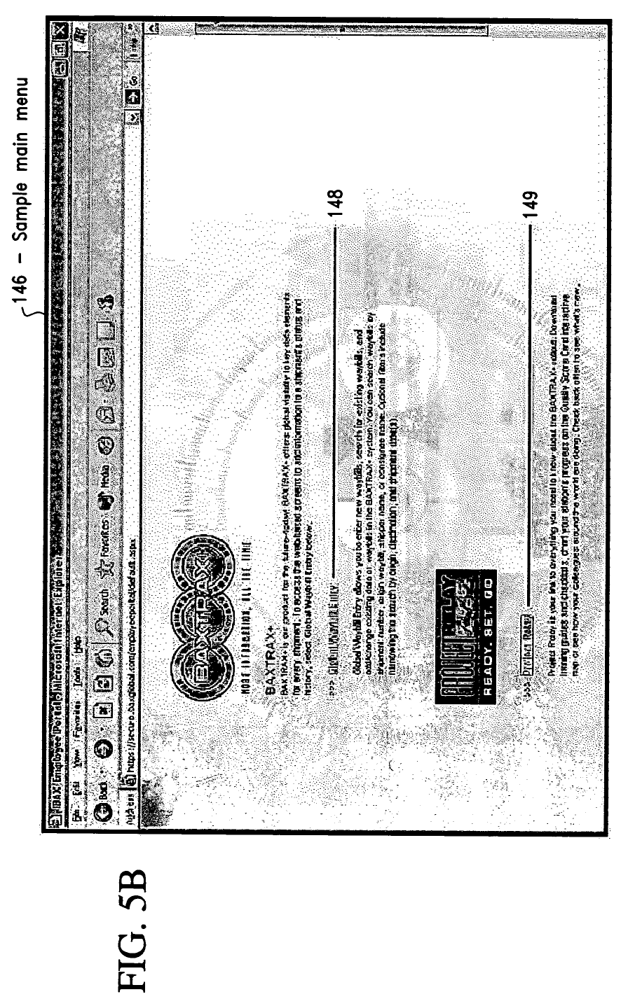

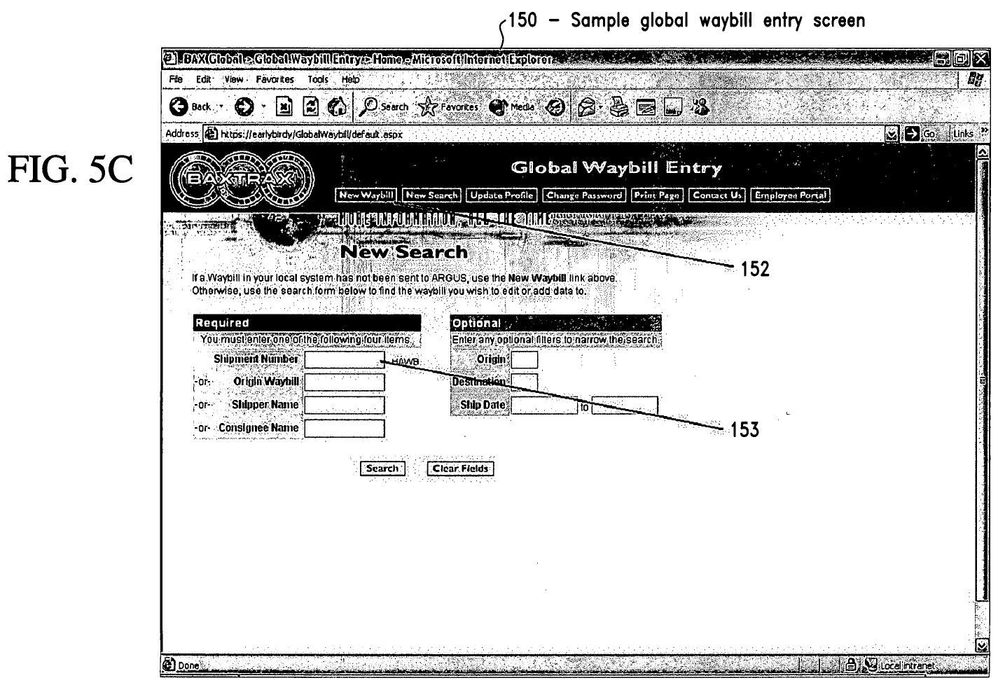

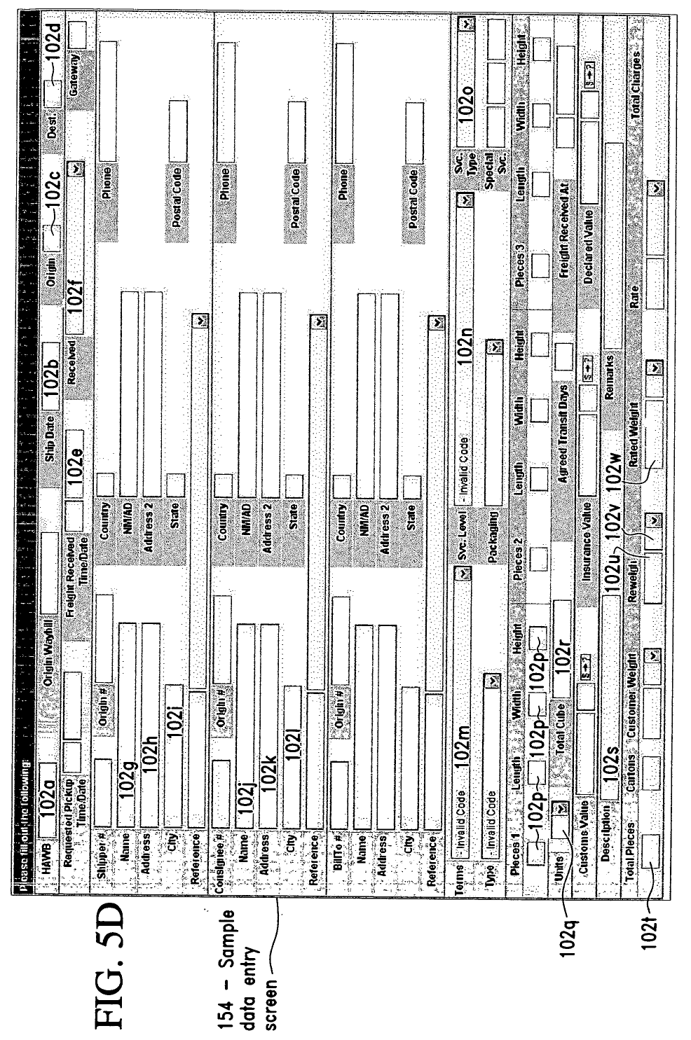

Referring now to a flow chart of FIG. 4, a method 110 is shown for accessing and entry of shipment data into the shipment tracking database 34 as shown in FIG. 1, whereby a system employee calls up a piece of software in the browser 16 and initiates a connection through the internet 20 to the web server 23. When the connection is made, the system employee in step 112 is shown a system log-on screen 140 as shown in FIG. 5A, whereby the system employee is prompted to enter their unique corporate e-mail address in data entry field 142 and their password in data entry field 144. In step 114, the system employee's entries are passed to the security software for validation. In step 116, the entered system employee's e-mail address and password is compared with a database 115 of authorized system employees or agents' e-mail addresses and passwords and, if there is a match, access to the system 10 is granted. If there is no match as determined in step 116, access is not granted, the system displays an error message in step 118, and the system employee is returned to step 112 where the system log-on screen 140 is again displayed.

Once access is granted in step 116, then a main menu 146 for the system 10 is displayed in step 120 as shown in FIG. 5B, which lists the plurality of systems to which the employee has been granted access. One of these choices is labeled “Global Waybill Entry” 148 as shown in FIG. 5B and the employee would select this choice in step 120 to access the memory 24 for web pages for data entry as shown in FIG. 1. They are then taken to a screen 150 shown in FIG. 5C that allows them to go to a blank waybill entry screen by selecting the “New Waybill” link 152 at the top of the screen in step 122, or update existing shipment data by entering the Shipment Number field 153.

For the purpose of explanation, we will assume that the system employee has selected the “New Waybill” screen in step 122. The data entry screen 154 is displayed in step 124, as shown in FIG. 5D and the system employee can then enter core date elements in a plurality of fields 102a through 102w on the selected screen in step 124, as well as entering other data that is not considered “core data”. The plurality of fields 102a-102w and the station responsible for their entry are defined as follows:

| | Data Element | | Responsible |
|---|---|---|---|
| Fields | Name | Description | Station |
| 102a | House Air Waybill | The number that identifies the shipment in | HAWB origin |
| | (HAWB) number. | Argus+ (BAX's data entry system). | |
| 102b | HAWB date. | The date when the shipment begins moving | HAWB origin |
| | | through the system. | |
| 102c | HAWB origin. | The three letter station code for the origin of the | HAWB origin |
| | | shipment. | |
| 102d | HAWB | The three letter station code for the destination of | HAWB origin |
| | destination. | the shipment. | |
| 102e | Freight received | The time-of-day/day-of-month the pickup was | HAWB origin |
| | time and date. | actually performed. | |
| 102f | Where freight | The two letter code which allows the user to | HAWB origin |
| | received. | identify where a shipment was picked up. | |
| 102g | Shipper name. | The name of the shipper. | HAWB origin |
| 102h | Shipper address. | The address of the shipper. | HAWB origin |
| 102i | Shipper city. | The name of the city where the shipper is located. | HAWB origin |
| 102j | Consignee name. | The name of the consignee. | HAWB origin |
| 102k | Consignee address. | The address of the consignee. | HAWB origin |
| 102l | Consignee city. | The name of the city where the consignee is | HAWB origin |
| | | located. | |
| 102m | Payment terms. | The requested payment terms for the HAWB. | HAWB origin |
| 102n | Service level. | A code that indicates the level of service for the | HAWB origin |
| | | shipment. | |
| 102o | Service type. | The two letter code indicating the type of service | HAWB origin |
| | | for the waybill. | |
| 102p | Package size. | The number of packages that are a particular | HAWB origin |
| | | length, width and height. Multiple entries can be | |
| | | made to accommodate many different packages. | |
| 102q | Unit of measure. | Unit of measure for package dimensions. | HAWB origin |
| 102r | Cubic measure. | The combined total cubic volume of the shipment. | HAWB origin |
| 102s | Description. | The description of the goods shipped. | HAWB origin |
| 102t | HAWB total | The total number of pieces in this shipment. | HAWB origin |
| | pieces. | | |
| 102u | Actual weight. | The weight of this shipment, as determined by | HAWB origin |
| | | BAX. | |
| 102v | Weight indicator. | A code that indicates whether the weight is in | HAWB origin |
| | | pounds (L) or Kilograms (K). | |
| 102w | Chargeable weight. | The weight used to calculate the freight charges. | HAWB origin |

Please note that the core data elements listed above are dynamic and can be changed by the system administrator. The listing above is meant to be a representative sample of the kinds of data elements being defined as “core data”.

In step 126, the web server 23 connects to the mainframe computer 30 via the corporate network 22. In step 128, all of the entered shipment data is sent through the corporate network 22 to a validation program in the shipment tracking software memory 32 which uses the same validation programs and criteria that were described for step 66 in FIG. 2 to ensure that the shipment data entered meets certain standards. If the data does not pass the validation in step 130, then an error message is returned in step 134 to the system employee and displayed on the data entry screen 154. The system employee can then correct the error and re-process the data until no errors are found. If the shipment data is validated in step 130, all of the entered data is written in step 132 into the shipment tracking database 34 as shown in FIG. 1.

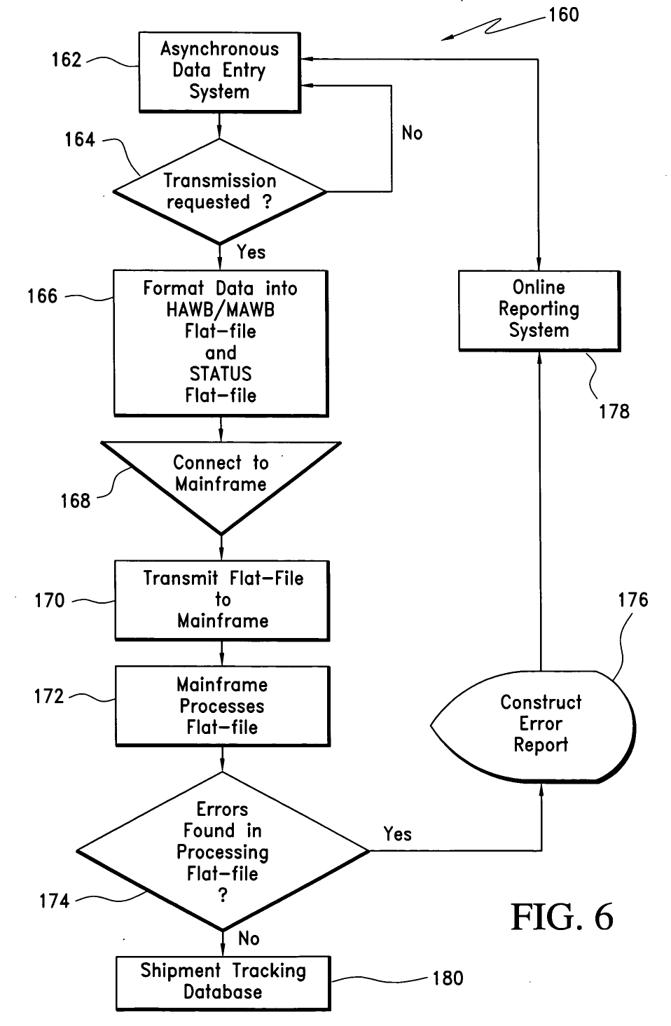

Referring now to the flow chart of FIG. 6, a method 160 is shown for accessing and entry of shipment data into the shipment tracking database 34 as shown in FIG. 1, whereby a system employee, agent or 3^{rd} party in step 162 calls up an asynchronous data entry system 18 and makes entries which are stored in a memory (not shown) in the data entry system 18. In step 164, the data entry system 18 determines if the system employee has manually requested a transmission, or if an internal trigger has been activated to request a transmission. Internal triggers vary between the systems, but the most common trigger occurs at the point when all shipments being tendered to a freight carrier under a specific master bill of lading have been electronically associated with that master bill of lading, and all the data entry needed to submit that master bill of lading to the freight carrier has been completed. This is called the “close” of the master bill. Other examples of potential triggers include the initial entry of shipment data, the close of the business day, a scheduled connection to the mainframe, or a change to the information regarding a shipment.

If a trigger has been activated or the system employee has requested a manual transmission, then in step 166 the data entry system 18 will copy a sub-set of the shipment data residing in the data entry system 18, the sub-set being identified in the specification below, into two types of flat-file (“flat-file” is a term denoting a file which contains data in a simple format which can be easily transmitted and read by different processing systems) according to a format specifications listed below, and then in step 168 initiates a connection through the corporate network 22 to the mainframe computer 30. When the connection is made, the data entry system 18 in step 170 transfers the flat files through the corporate network 22 to the mainframe computer 30. In step 172, on a cycle that occurs every 20 minutes throughout the day, the mainframe computer 30 executes a series of programs stored in the shipment tracking software memory 32 that opens the flat-files and extracts the data from it. In step 174, the tracking kept in the memory 32 programs examine the flat-file data to determine if any errors exist, based on the criteria listed below. If errors are encountered during the process, then in step 176 the data is rejected and a report is constructed containing information about the errors which is then placed in the company's online report system where it can be retrieved by the person responsible for monitoring the data exchange between the originating station 11 and the mainframe computer 30. If no errors are encountered, then in step 180 the data from the flat-files is transferred to, and stored in, the shipment tracking database 34.

Once initial shipment data has been sent from the data entry system 18 to the mainframe computer 30, a system employee at a station 11 can use one of the other two methods described above to enter any data elements that their data entry system is incapable of capturing.

The purpose of the transmission specification is to ensure that all entities are using a standard format which will allow the data in these flat-files to be accepted and stored in the shipment tracking database 34. Not all data residing in the data entry systems 18 regarding a shipment is transmitted to the mainframe computer 30. Only that data which matches the specification is included in the transmission. Please note that the specification listed below is dynamic and can be changed. It is included here only as an illustrative embodiment of this invention.

The specifications for the format of the flat-file containing HAWB/MAWB information are as follows:

| | MAWB | HAWB | | | Length | Start | Ending | | Notes & |
|---|---|---|---|---|---|---|---|---|---|
| Field Name | Field | Field | Multiple? | Type | (bytes) | Pos | Pos | Comments | Codes |
| Header | M | M | No | | | | | Beginning Of | 14 |
| Record | | | | | | | | Transmission | |
| Record Identifier | M | M | | A | 3 | 1 | 3 | “BEG” | |
| Document | M | M | | A | 10 | 4 | 13 | “BAXDOC” | 16 |
| Identifier | | | | | | | | | |
| Origin Of | M | M | | A | 15 | 14 | 28 | Station or processor site; | |
| Transmission | | | | | | | | e.g. ‘LHR’ | |
| Origin Qualifier | O | O | | A | 2 | 29 | 30 | “ZZ” | |
| Dest Of | M | M | | A | 15 | 31 | 45 | “HDQ” | 13 |
| Transmission | | | | | | | | | |
| Destination | O | O | | A | 2 | 46 | 47 | “ZZ” | |
| Qualifier | | | | | | | | | |
| Date Of | M | M | | A | 8 | 48 | 55 | YYYYMMDD; e.g. | |
| Transmission | | | | | | | | ‘19970521’ | |
| Time Of | M | M | | A | 6 | 56 | 61 | HHMMSS; e.g. ‘210235’ | |
| Transmission | | | | | | | | | |
| Sequence Number | O | O | | N | 9 | 62 | 70 | see note | 12 |
| H01 Record | M | M | No | | | | | First Data Record | |
| Record Identifier | M | M | | A | 3 | 1 | 3 | “H01” | |
| Document | M | M | | A | 3 | 4 | 6 | “741” (MAWB) or | |
| Identifier | | | | | | | | “742” (HAWB) | |
| HAWB Number | | | M | A | 12 | 7 | 18 | HAWB number (Air or | |
| | | | | | | | | Ocean) | |
| Carrier Number | M | | | A | 4 | 19 | 22 | Carrier code of the | |
| | | | | | | | | MAWB (Air or Ocean) | |
| MAWB Number | M | | | A | 11 | 23 | 33 | MAWB number; e.g. | |
| | | | | | | | | ‘019058550’ (Air only). | |
| Linked MAWB | | C | | A | 4 | 34 | 37 | Carrier code of the | 3 |
| Carrier Number | | | | | | | | linked MAWB to which | |
| | | | | | | | | this HAWB is assigned | |
| | | | | | | | | (Air or Ocean). | |
| Linked MAWB | | C | | A | 11 | 38 | 48 | MAWB number to | 23 |
| Number | | | | | | | | which this HAWB is | |
| | | | | | | | | assigned (Air only). | |
| Ship Date | M | M | | A | 8 | 49 | 56 | YYYYMMDD; e.g. | |
| | | | | | | | | ‘19970521’. | |
| Pick Up | | C | | A | 4 | 57 | 60 | MMDD; e.g. ‘0521’ | |
| Month/Day | | | | | | | | | |
| Pick Up Time | | C | | A | 4 | 61 | 64 | HHMM 24-hour format; | |
| | | | | | | | | e.g. ‘1721’ | |
| Currency Code | M | M | | A | 3 | 65 | 67 | Standard IATA codes; | |
| | | | | | | | | e.g. ‘USD’ | |
| MAWB/HAWB | M | M | | A | 2 | 68 | 69 | MAWB/HAWB type | 6 |
| Type | | | | | | | | (see note) | |
| HAWB Service | | M | | A | 6 | 70 | 75 | HAWB service level | 7 |
| Level | | | | | | | | (see note) | |
| HAWB Service | | M | | A | 2 | 76 | 77 | HAWB service type (see | 19 |
| Type | | | | | | | | note) | |
| DTD Date | | | | A | 20 | 78 | 97 | future use | |
| BAX ID | | | | A | 3 | 98 | 100 | future use | |
| BAX ID Loc | M | M | | A | 2 | 101 | 102 | Alert country code | |
| Ocean MAWB | M | | | A | 12 | 103 | 114 | Ocean MAWB number; | |
| Number | | | | | | | | e.g.; ‘IDNLTY718578’ | |
| Linked Ocean | | C | | A | 12 | 115 | 126 | Ocean MAWB number | 23 |
| MAWB Number | | | | | | | | to which this Ocean | |
| | | | | | | | | HAWB is assigned. | |
| Linked Ocean | | C | | A | 4 | 127 | 130 | Ocean MAWB origin to | 23 |
| MAWB Origin | | | | | | | | which this Ocean | |
| | | | | | | | | HAWB is assigned. | |
| Ocean Booking | C | | | A | 20 | 131 | 150 | Ocean booking number | |
| Ref. | | | | | | | | originally provided by | |
| | | | | | | | | the Ocean carrier. | |
| Original Waybill | | O | | A | 12 | 151 | 162 | Note 28 (original | |
| (HAWB) | | | | | | | | offshore hawb) | |
| AD-Master | | C | | A | 12 | 163 | 174 | Note 29 (assembly - | |
| (HAWB) | | | | | | | | distribution) | |
| H02 Record | M | M | No | | | | | Totals and Declared | |
| | | | | | | | | Values | |
| Record Identifier | M | M | | A | 3 | 1 | 3 | “H02” | |
| Charge Field | M | M | | N5.4 | 12 | 4 | 15 | Multiplier used to | 20 |
| Multiplier | | | | | | | | calculate H02 chg | |
| | | | | | | | | values. | |
| Decl Value For | C | C | | N7.2 | 12 | 16 | 27 | | 10 |
| Carriage | | | | | | | | | |
| Decl Value For | C | C | | N7.2 | 12 | 28 | 39 | | 10 |
| Customs | | | | | | | | | |
| Decl Value For | C | C | | N7.2 | 12 | 40 | 51 | | 10 |
| Insur. | | | | | | | | | |
| Total PPD Wgt | C | C | | N7.2 | 12 | 52 | 63 | | 10 |
| Charges | | | | | | | | | |
| Total PPD Val | C | C | | N7.2 | 12 | 64 | 75 | | 10 |
| Charges | | | | | | | | | |
| Total PPD Tax | C | C | | N7.2 | 12 | 76 | 87 | | 10 |
| Amount | | | | | | | | | |
| Total PPD Due | C | | | N7.2 | 12 | 88 | 99 | | 10 |
| Agent | | | | | | | | | |
| Total PPD Due | C | | | N7.2 | 12 | 100 | 111 | | 10 |
| Carrier | | | | | | | | | |
| Total COL Wgt | C | C | | N7.2 | 12 | 112 | 123 | | 10 |
| Charges | | | | | | | | | |
| Total COL Val | C | C | | N7.2 | 12 | 124 | 135 | | 10 |
| Charges | | | | | | | | | |
| Total COL Tax | C | C | | N7.2 | 12 | 136 | 147 | | 10 |
| Amount | | | | | | | | | |
| Total COL Due | C | | | N7.2 | 12 | 148 | 159 | | 10 |
| Agent | | | | | | | | | |
| Total COL Due | C | | | N7.2 | 12 | 160 | 171 | | 10 |
| Carrier | | | | | | | | | |
| Weight Chg Due | C | | | A | 1 | 172 | 172 | | |
| Agt/Carr | | | | | | | | | |
| H03 Record | O | O | Yes | | | | | Text Record (Air & | |
| | | | | | | | | Ocean) | |
| Record Identifier | M | M | | A | 3 | 1 | 3 | “H03” | |
| Text Type Code | M | M | | A | 3 | 4 | 6 | e.g. OSI, Z01 (see notes) | 1 |
| Text Line 1 | M | M | | A | 70 | 7 | 76 | Free text, at least one | |
| | | | | | | | | line is required if the | |
| | | | | | | | | H03 record is present. | |
| Text Line 2 | C | C | | A | 70 | 77 | 146 | Free text | |
| Text Line 3 | C | C | | A | 70 | 147 | 216 | Free text | |
| H03 Record | | C | No | | | | | Text Record (Ocean) | |
| Record Identifier | | M | | A | 3 | 1 | 3 | “H03” | |
| Text Type Code | | M | | A | 3 | 4 | 6 | VS1 (Vessel Record; see | 17 |
| | | | | | | | | note) | |
| Shipping Line | | M | | A | 20 | 7 | 26 | e.g ‘Hyundai’ | |
| Vessel Name | | M | | A | 20 | 27 | 46 | e.g. ‘Hyundai Freedom’ | |
| Voyage Number | | M | | A | 20 | 47 | 66 | e.g. ‘008E’ | |
| H03 Record | | C | Yes | | | | | Text Record (Ocean) | |
| Record Identifier | | M | | A | 3 | 1 | 3 | “H03” | |
| Text Type Code | | M | | A | 3 | 4 | 6 | CN1 (Container Record; | 17 |
| | | | | | | | | see note) | |
| Container Number | | M | | A | 20 | 7 | 26 | e.g. ‘HDMU6029600’ | |
| Container Size | | M | | A | 20 | 27 | 46 | e.g. “40′” | |
| FCL/LCL | | M | | A | 1 | 47 | 47 | “F” (Full) or “L” (Less | |
| | | | | | | | | than full) container load. | |
| Container Volume | | M | | A | 20 | 48 | 67 | e.g. ‘6.05’ (always cubic | |
| | | | | | | | | meters) | |
| Seal Number | | M | | A | 8 | 68 | 75 | e.g. ‘225829’ | |
| H04 Record | M | M | No | | | | | Codes Record | |
| Record Identifier | M | M | | A | 3 | 1 | 3 | “H04” | |
| Origin Code | M | M | | A | 25 | 4 | 28 | Origin airport code | |
| | | | | | | | | (IATA) | |
| Destination Code | M | M | | A | 25 | 29 | 53 | Final destination airport | 11 |
| | | | | | | | | code | |
| Charge Payment | | | | A | 3 | 54 | 56 | Future use | |
| Instruct | | | | | | | | | |
| Charge Payment | | M | | A | 3 | 57 | 59 | HAWB Payment terms, | |
| Code | | | | | | | | ‘P’, ‘C’, ‘F’, ‘T’, or ‘3’. | |
| Wgt/Val Chgs - | O | | | A | 2 | 60 | 61 | “P” or “C” | 4 |
| PPD/COL | | | | | | | | | |
| Other Chgs - | O | | | A | 2 | 62 | 63 | “P” or “C” | 5 |
| PPD/COL | | | | | | | | | |
| INCO Terms | | O | | A | 6 | 64 | 69 | International Payment | 25 |
| | | | | | | | | Terms | |
| Special Service | | O | | A | 4 | 70 | 73 | see note 26 | |
| Code 1 | | | | | | | | | |
| Special Service | | O | | A | 4 | 74 | 77 | see note 26 | |
| Code 2 | | | | | | | | | |
| Special Service | | O | | A | 4 | 78 | 81 | see note 26 | |
| Code 3 | | | | | | | | | |
| MAWB Origin | C | | | A | 3 | 82 | 84 | see note 27 (d/l only) | |
| (BAX) | | | | | | | | | |
| HAWB Commit | | O | | A | 8 | 85 | 92 | BAX's Delivery Commit | |
| Date | | | | | | | | Date (u/l only) | |
| HAWB Commit | | O | | A | 4 | 93 | 96 | BAX's Delivery Commit | |
| Time | | | | | | | | Time (u/l only) | |
| H05 Record | O | O | Yes | | | | | Other Charges | |
| Record Identifier | M | M | | A | 3 | 1 | 3 | “H05” | |
| Charge Field | M | M | | N5.4 | 12 | 4 | 15 | Multiplier used to | 20 |
| Multiplier | | | | | | | | calculate H05 chg | |
| | | | | | | | | values. | |
| Charge Code | M | M | | A | 2 | 16 | 17 | Charge code (two-digit) | 8 |
| Charge Descrip | O | O | | A | 25 | 18 | 42 | Charge description (text) | |
| PPD/COL Code | M | M | | A | 1 | 43 | 43 | “P” or “C” | |
| Due Agt/Carr | M | | | A | 3 | 44 | 46 | “A” (agent) or “C” | |
| Code | | | | | | | | (carrier) | |
| Charge Amt | M | M | | N9.2 | 12 | 47 | 58 | Other charge amount | 10 |
| Charge Code | C | C | | A | 4 | 59 | 62 | Charge code (four | 24 |
| (alternate) | | | | | | | | character Argus code) | |
| Other Chg Due | C | | | A | 1 | 63 | 63 | | |
| Agt/Carr | | | | | | | | | |
| H06 Record | M | | Yes | | | | | Flight Leg Record (at | 2 |
| | | | | | | | | least one req'd) | |
| Record Identifier | M | | | A | 3 | 1 | 3 | “H06” | |
| Air Carrier | M | | | A | 3 | 4 | 6 | Air carrier IATA code | |
| | | | | | | | | for this flight leg; e.g. | |
| | | | | | | | | ‘BA’. | |
| Flight Number | M | | | A | 6 | 7 | 12 | Flight (or leg) number; | |
| | | | | | | | | ‘17920’ | |
| Flight Origin | M | | | A | 25 | 13 | 37 | Origin IATA code; e.g. | |
| | | | | | | | | ‘LHR’ | |
| Scheduled Flight | M | | | A | 8 | 38 | 45 | YYYYMMDD; e.g. | |
| Date | | | | | | | | ‘19970320’ | |
| Flight Destination | M | | | A | 25 | 46 | 70 | Destination IATA code; | |
| | | | | | | | | e.g. ‘JFK’ | |
| Flight ETD Date | O | | | A | 8 | 71 | 78 | YYYYMMDD; e.g. | |
| | | | | | | | | ‘19970320’ | |
| Flight ETD Time | O | | | A | 4 | 79 | 82 | HHMM; e.g. ‘2100’ | |
| Flight ETA Date | M | | | A | 8 | 83 | 90 | YYYYMMDD; e.g. | |
| | | | | | | | | ‘19970321’ | |
| Flight ETA Time | M | | | A | 4 | 91 | 94 | HHMM; e.g. ‘0321’ | |
| Flight ATD Date | O | | | A | 8 | 95 | 102 | YYYYMMDD | |
| Flight ATD Time | O | | | A | 4 | 103 | 106 | HHMM | |
| Flight ATA Date | O | | | A | 8 | 107 | 114 | YYYYMMDD | |
| Flight ATA Time | O | | | A | 4 | 115 | 118 | HHMM | |
| Ocean Carrier | C | | | A | 4 | 119 | 122 | Ocean carrier SCAC | |
| | | | | | | | | code for this leg; e.g. | |
| | | | | | | | | ‘OCNU’. | |
| H07 Record | M | M | Yes | | | | | Participant Record #1 | |
| Record Identifier | M | M | | A | 3 | 1 | 3 | “H07” | |
| ID | M | M | | A | 2 | 4 | 5 | “CZ”, “CN”, “CG” | 9 |
| Name Line 1 | M | M | | A | 35 | 6 | 40 | free text | |
| Name Line 2 | O | O | | A | 35 | 41 | 75 | free text | |
| Address Line 1 | M | M | | A | 35 | 76 | 110 | free text | |
| Address Line 2 | O | O | | A | 35 | 111 | 145 | free text | |
| City Name | M | M | | A | 21 | 146 | 166 | free text | |
| State | C | C | | A | 6 | 167 | 172 | State code (if applicable) | |
| Postal Code | O | O | | A | 9 | 173 | 181 | e.g. ‘92656’ | |
| Country Code | M | M | | A | 3 | 182 | 184 | IATA country code; e.g. | |
| | | | | | | | | ‘GB’ | |
| BAX Customer | O | O | | N | 9 | 185 | 193 | BAX CMF number; e.g. | |
| Nbr | | | | | | | | ‘93437201’ | |
| Contact | O | O | | A | 25 | 194 | 218 | Contact person (free | |
| | | | | | | | | text) | |
| Contact Phone | O | O | | A | 25 | 219 | 243 | Contact phone number | |
| Nbr. | | | | | | | | (free text) | |
| D01 Record | M | M | Yes | | | | | Shipment Detail Record | |
| Record Identifier | M | M | | A | 3 | 1 | 3 | “D01” | |
| Line Number | C | C | | N | 6 | 4 | 9 | Line number of item | |
| Number Of Items | M | M | | N | 8 | 10 | 17 | Pieces | |
| Container | | | | A | 3 | 18 | 20 | not currently used | |
| Qualifier | | | | | | | | | |
| Rate Comb Point | | | | A | 25 | 21 | 45 | not currently used | |
| Item Description | C | C | | A | 70 | 46 | 115 | free text | |
| Dim Unit Code | | C | | A | 3 | 116 | 118 | Defines the units for | 22 |
| | | | | | | | | length, width, and | |
| | | | | | | | | height. | |
| Dim Length | | C | | A | 5 | 119 | 123 | Overall length of the | |
| | | | | | | | | item. | |
| Dim Width | | C | | A | 5 | 124 | 128 | Overall width of the | |
| | | | | | | | | item. | |
| Dim Height | | C | | A | 5 | 129 | 133 | Overall height of the | |
| | | | | | | | | item. | |
| Dim Pieces | | C | | A | 9 | 134 | 142 | Not currently entered on | |
| | | | | | | | | MAWB | |
| Act Weight | M | M | | A | 3 | 143 | 145 | “KGR” or “KGM” | |
| Qualifier | | | | | | | | | |
| Actual Weight | M | M | | N7.1 | 8 | 146 | 153 | | |
| Chg Weight | C | C | | A | 3 | 154 | 156 | “KGR” or “KGM” | |
| Qualifier | | | | | | | | | |
| Chargeable | C | C | | N7.1 | 8 | 157 | 164 | | |
| Weight | | | | | | | | | |
| Charge Field | C | C | | N5.4 | 12 | 165 | 176 | Multiplier used to | 21 |
| Multiplier | | | | | | | | calculate D01 rte/chg | |
| | | | | | | | | values. | |
| Rate | C | C | | N9.2 | 12 | 177 | 188 | Tariff rate applicable to | 10 |
| | | | | | | | | this item. | |
| Tariff | C | C | | A | 6 | 189 | 194 | | |
| Total Item | C | C | | N7.2 | 12 | 195 | 206 | Total charge for this | 10 |
| Charges | | | | | | | | item. | |
| Commodity Code | C | C | | A | 10 | 207 | 216 | | |
| S01 Record | M | M | No | | | | | Summary Record | |
| Record ID | M | M | | A | 3 | 1 | 3 | “S01” | |
| Total Pieces | M | M | | N | 7 | 4 | 10 | Total HAWB or MAWB | |
| | | | | | | | | pieces | |
| Total Weight | M | M | | N8.1 | 12 | 11 | 22 | Total HAWB or MAWB | |
| | | | | | | | | weight. Units must be | |
| | | | | | | | | the same used in the | |
| | | | | | | | | D01 record. | |
| Trailer Record | M | M | No | | | | | End Of Transmission | |
| Record Identifier | M | M | | A | 3 | 1 | 3 | “END” | |
| Number Of | M | M | | N | 5 | 4 | 8 | Total segments, not | 15 |
| Segments | | | | | | | | including ‘BEG’ & | |
| | | | | | | | | ‘END’ | |
| Number Of | M | M | | N | 5 | 9 | 13 | See note | 15 |
| Documents | | | | | | | | | |
| Sequence Number | O | O | | N | 9 | 14 | 22 | See note | 13 |

Legend:
“M” = Mandatory
“O” = Optional
“C” = Conditional
“A” = Alpha-numeric
“N” = Numeric
HAWB = House Air WayBill (the receipt between the system administrator and the customer)
MAWB = Master Air WayBill (the receipt between the system administrator and the freight carrier)

The specifications for the format of the flat-file containing STATUS information are as follows:

| | MAWB | HAWB | | | Length | Start | Ending | | Notes & |
|---|---|---|---|---|---|---|---|---|---|
| Field Name | Field | Field | Multiple? | Type | (bytes) | Pos | Pos | Comments | Codes |
| Header Record | M | M | No | | | | | Beginning Of Transmission | 14 |
| Record Identifier | M | M | | A | 3 | 1 | 3 | “BEG” | |
| Type Of | M | M | | A | 10 | 4 | 13 | “BAXSTAT” | 16 |
| Transmission | | | | | | | | | |
| Origin Of | M | M | | A | 15 | 14 | 28 | Station or processor site; e.g. | |
| Transmission | | | | | | | | ‘LHR’ | |
| Origin Qualifier | O | O | | A | 2 | 29 | 30 | “ZZ” | |
| Dest Of | M | M | | A | 15 | 31 | 45 | “HDQ” | 13 |
| Transmission | | | | | | | | | |
| Destination | O | O | | A | 2 | 46 | 47 | “ZZ” | |
| Qualifier | | | | | | | | | |
| Date Of | M | M | | A | 8 | 48 | 55 | YYYYMMDD; e.g. | |
| Transmission | | | | | | | | ‘19970521’ | |
| Time Of | M | M | | A | 6 | 56 | 61 | HHMMSS; e.g. ‘210235’ | |
| Transmission | | | | | | | | | |
| Sequence Number | O | O | | N | 9 | 62 | 70 | see note | 12 |
| H01 Record | M | M | No | | | | | First Data Record | |
| Record Identifier | M | M | | A | 3 | 1 | 3 | “H01” | |
| Document | M | M | | A | 3 | 4 | 6 | “741” (MAWB) or “742” | |
| Identifier | | | | | | | | (HAWB) | |
| HAWB Number | | M | | A | 12 | 7 | 18 | HAWB number; e.g. | |
| | | | | | | | | ‘001167478’ | |
| Carrier Number | M | | | A | 4 | 19 | 22 | Carrier code of the MAWB | |
| | | | | | | | | (e.g. ‘0001’) | |
| MAWB Number | M | | | A | 11 | 23 | 33 | MAWB number; e.g. | |
| | | | | | | | | ‘072750978’ | |
| HAWB/MAWB | M | M | | A | 4 | 34 | 37 | Origin airport IATA code; | |
| Origin | | | | | | | | e.g. ‘DTW’ | |
| HAWB Destination | | M | | A | 4 | 38 | 41 | Destination airport IATA | |
| | | | | | | | | code; e.g. ‘LHR’ | |
| Deliv/Recov | M | M | | A | 4 | 42 | 45 | HAWB Delivery Code (see | 18 |
| Status/Event | | | | | | | | note) | |
| | | | | | | | | MAWB Recovery Code (see | |
| | | | | | | | | note) Additional Mawb | |
| | | | | | | | | Events(Valid Values: ATD, | |
| | | | | | | | | ATA, LDT) | |
| Deliv/Recvry/Event | M | M | | A | 8 | 46 | 53 | YYYYMMDD; e.g. | |
| Date | | | | | | | | ‘19970521’. | |
| Deliv/Recvry/Event | M | M | | A | 4 | 54 | 57 | HHMM 24-hour format; e.g. | |
| Time | | | | | | | | ‘1721’ | |
| Deliv/Recvry Type | | M | | A | 1 | 58 | 58 | P′ - partial, or ‘T’ - total | |
| Deliv/Recvry | | M | | A | 8 | 59 | 66 | Pieces delivered or recovered | |
| Pieces | | | | | | | | | |
| Delivered Weight | | M | | N7.1 | 8 | 67 | 74 | Weight of pieces delivered. | |
| Delivered Wgt | | M | | A | 3 | 75 | 77 | “KGR” or “KGM” | |
| Qualifier | | | | | | | | | |
| Ocean MAWB | M | | | A | 12 | 78 | 89 | Ocean MAWB number; e.g.; | |
| Number | | | | | | | | ‘IDNLTY718578’ | |
| Leg Org | | | | A | 3 | 90 | 92 | Origin of the Leg(For which | |
| | | | | | | | | the ATD/ATA Belongs) | |
| Leg Dst | | | | A | 3 | 93 | 95 | Destination of the Leg(For | |
| | | | | | | | | which the ATD/ATA | |
| | | | | | | | | belongs) | |
| Actual Date Time | | | | A | 12 | 96 | 107 | The actual GMT Date time in | |
| | | | | | | | | YYYYMMDDHHII format | |
| | | | | | | | | of when this | |
| | | | | | | | | event(ATA/ATD/LDT/Status) | |
| | | | | | | | | happened in your system. | |
| H02 Record | C | M | No | | | | | Text Record | |
| Record Identifier | M | M | | A | 3 | 1 | 3 | “H02” | |
| Broker Code | | C | | A | 4 | 4 | 7 | Mandatory if deliv code = “DB” | |
| Received By | | M | | A | 15 | 8 | 22 | Delivery signature, broker, | |
| | | | | | | | | etc. | |
| Deliv/Recvry | C | C | | A | 60 | 23 | 82 | Delivery or recovery | |
| Comment | | | | | | | | comments | |
| Trailer Record | M | M | No | | | | | End Of Transmission | |
| Record Identifier | M | M | | A | 3 | 1 | 3 | “END” | |
| Number Of | M | M | | N | 5 | 4 | 8 | Total segments, not including | 15 |
| Segments | | | | | | | | ‘BEG’ & ‘END’. | |
| Number Of | M | M | | N | 5 | 9 | 13 | see note | 15 |
| Documents | | | | | | | | | |
| Sequence Number | O | O | | N | 9 | 14 | 22 | see note | 13 |

Each flat file transmitted to the mainframe is validated against the following criteria:

1. HAWB number must be digits.

2. Dates must be in YYYYMMDD format.

3. Times must be in HHMM format.

4. Dates must be within a range of 60 days in the past to 1 day in the future.

5. The origin station code must be valid when compared to the data in the stations database in the Mainframe computer 30.

6. The destination station code must be valid when compared to the data in the stations database in the Mainframe computer 30.

7. The Weight Qualifier must be “KGR” or “KGM” (Kilograms) or blank (Pounds).

8. All segments of the flat file must be recognized as part of the structure defined in the previous sections.

Please note that the validation criteria listed above is dynamic and can be changed. It is included here only as an illustrative embodiment of this invention.

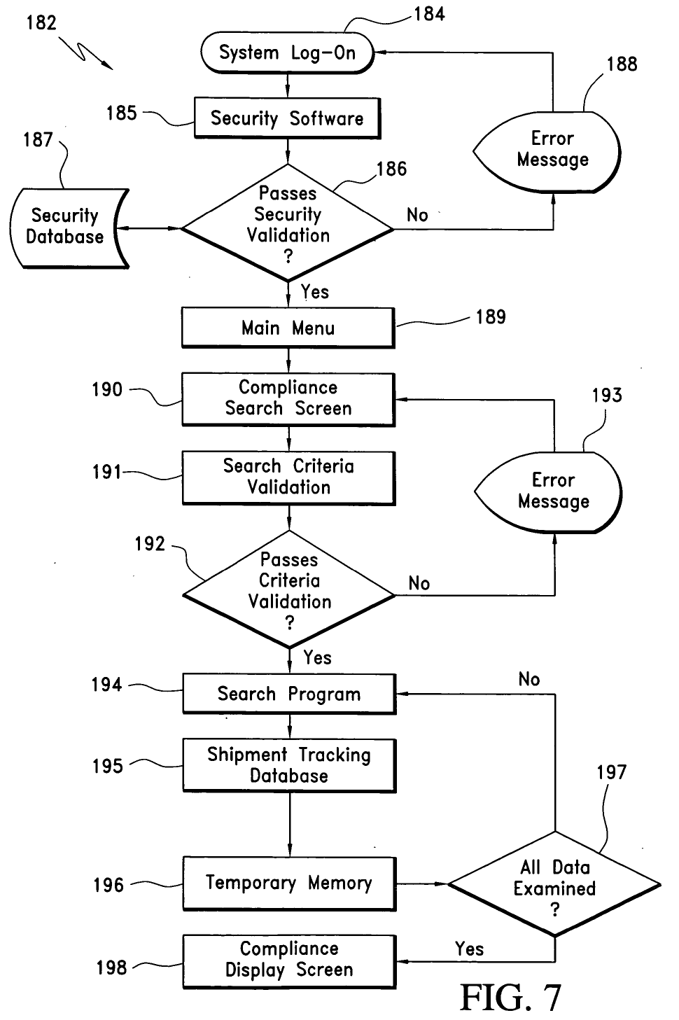

Referring now to the flow chart of FIG. 7, a method 182 is shown for requesting and displaying compliance data directly from the shipment tracking database 34 as shown in FIG. 1, whereby a system employee calls up a piece of terminal emulator software 14 and initiates a connection through the corporate network 22 to the mainframe computer 30. Compliance data, like Tracking data, is a sub-set of Shipment data. Compliance refers to the core data elements and whether or not the data has been entered into all of the core elements for a specific shipment. When the connection is made, the system employee in step 184 is shown a system log-on screen 80 as shown in FIG. 3A, whereby the system employee is prompted to enter their unique user ID in data entry field 82 and their password in data entry field 84. In step 185, the system employee's entries are passed to the security software for validation. In step 186, the entered system employee's ID and password are compared with the authorized system employees or agents' IDs and passwords as stored in a security database 187 and, if there is a match, access to the system 10 is granted. If there is no match as determined in step 186, access is not granted, the system displays an error message in step 188, and the system employee is returned to step 184 where the system log-on screen 80 is again displayed.

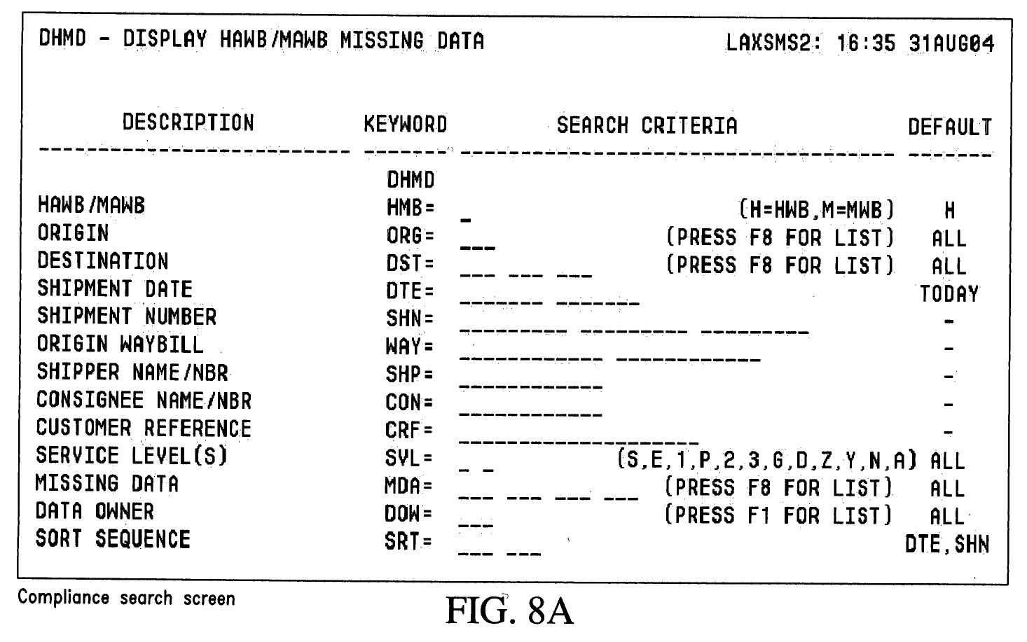

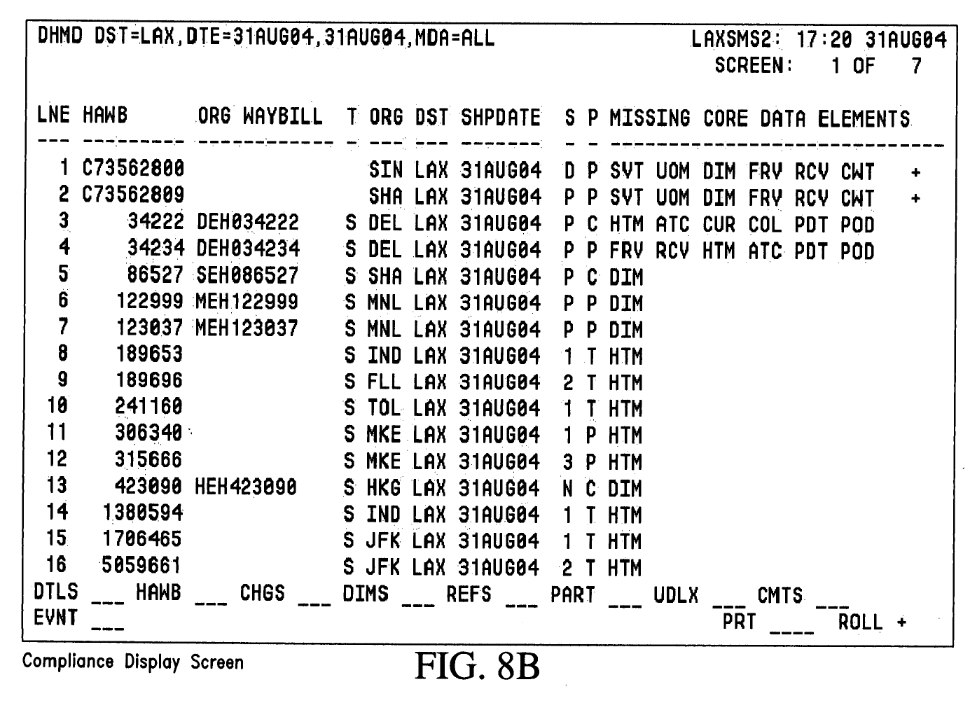

Once access is granted in step 186, then a main menu 90 for the system 10 displays in step 189 as shown in FIG. 3B. From the main menu, the system employee can then navigate to the compliance search screen, which is shown in FIG. 8A. In step 190, the system employee can then enter criteria that identifies a shipment or group of shipments. In step 191, that search criteria is then validated by the shipment tracking software 32. In step 192, the shipment tracking software 32, determines whether or not the search criteria has passed validation. If it does not pass validation, then in step 193 an error message is displayed to the system employee who can then re-enter criteria until it has been validated. Once the criteria have been determined to be valid in step 192, the compliance search program 194 searches in step 195 the shipment tracking database 34 for shipments that match the search criteria. When a shipment is found that matches, the shipment record is then stored in a temporary memory 196. The shipment record is then examined to see if the core data elements for that shipment have entries. Each element that does not have an entry is identified by the software and given a code which is then stored in a temporary memory 196. In step 197, the compliance search program determines if the entire database 34 has been searched and, if not, continues searching the database 34 for more matches, with each match being stored in a temporary memory 196, until the entire database 34 has been searched. Once the search program determines in step 197 that the entire database 34 has been searched, it produces in step 198 a display screen that lists each of the shipments stored in the temporary memory 196, and displays a code for each of the missing core data elements for that shipment as shown in FIG. 8B. The system employee can then use any of the links at the bottom of the screen to access the appropriate entry screen needed to correct the missing core data element. Since these updates occur in real-time, each correction made by a system employee is reflected by the compliance screen upon re-display.

Referring now to the flow chart of FIG. 9A, a method 200 is shown for copying shipment data from the shipment tracking database 34 as shown in FIG. 1, and transferring it to the data warehouse computer 40 where it is available for customer reporting and where compliance data is analyzed in order to calculate compliance statistics. In other words, compliance data is analyzed to create compliance statistics. Compliance statistics are then transferred to data storage areas within the data warehouse 40 which store those statistics for a daily, weekly and monthly date range. A program then reads the statistics in those storage areas and creates a set of reports which are then transferred to the memory 26 for web pages for compliance reporting found on the web server 23 where they can be viewed by system employees or agents.

In an illustrative embodiment of this invention, a program stored in the shipment tracking software memory 32 executes illustratively in step 202 each weekday night at 3AM Pacific Standard Time. This program examines all of the shipment data in the shipment tracking database 34, and any shipment data element found with a time/date stamp that is later than the last time the program ran is copied into a temporary file 203 which is stored on the corporate network 22.

In step 204, the data warehouse computer 40 connects to the corporate network 22 and, in step 206, the copied data file is extracted and transferred to the computer of the data warehouse 40. When the extraction of shipment data is completed, a program stored in the memory 41 for programs for compliance and reporting executes in step 208. This program appends the copied shipment data to any previously existing shipment data in the shipment history database 43 in much the same way that, in a spreadsheet, a line of numbers is appended to existing lines of numbers, thus creating and maintaining a history of the company's shipment activity which is available for customer reporting and compliance analysis.

The step 210 as generally shown in FIG. 9A is shown in detail as a program 210′ in FIG. 9B. This program 210′ analyzes the core data as identified in the data warehouse 40 to create a set of statistics that defines the error rate of a station 11. There is no further data extraction at this point. All of the data has been extracted from the mainframe 30 and copied into the data warehouse 40. All of the compliance programs from this point forward simply analyze the data. The program 210′ examines the core data elements for a particular shipment and determines whether or not data has been entered into each core data element. Initially in step 220, the data is examined to identify each core data elements which is associates with a particular shipment. Next in step 222, the core data identified in the database 43 is examined to determine for each shipment, which of the four stations 11a-d were involved in the shipment's shipment-cycle and which role each station 11 played. As mentioned before, a single station 11 is not responsible for providing all of the core data elements for a single shipment. The responsibility for entering core data is divided between the origin station 11a for the HAWB (housebill), the destination station 11b for the HAWB, the origin station 11c for the MAWB (masterbill) and the destination station 11d for the MAWB.) Once the roles of the stations 11 involved with that shipment have been identified, the program 210′ then examines in step 224 each core data element for that shipment to determine if the shipment data has been entered in the core data element and tallies or counts the elements with entered data against the responsible station 11. In particular, step 224 determines for each of the four responsible stations 11a-d, the number of possible errors. “Possible Errors” are determined by counting the number of data elements a station is responsible for. The total number of data elements is the total number of “possible errors”. Next in step 226, the program 210′ counts for each shipment how many core data elements have data in them. Then step 228 subtracts the number of core data elements which have received data therein from the number of possible errors for a corresponding one of the responsible stations to obtain the number of actual errors, i.e., the number of core data elements in which no data is entered. Then in step 230, the number of elements without data is logged or stored. After the actual number of errors is calculated in step 230, step 232 determines whether all of the shipment data elements have been read from the shipment history database 43 and, if not, the program 210′ returns to step 220, whereby the steps 220 through 230 are repeated for each core data element until each element residing in the warehouse 40 has been analyzed.

After all of the shipment data has been extracted and analyzed as determined in step 232, the program 210′ moves to step 234, where the total number of possible errors for each station 11 is determined. Then the number of actual errors is counted for each station 11 in step 234 and the total number of actual errors is determined for each station 11. Thereafter, the total number of actual errors is divided in step 238 by the total number of possible errors to calculate for its corresponding responsible station 11 an error rate for each core data element for which a corresponding station 11 was responsible. Next, the error rate as allocated to each station 11 is then divided in step 240 by 100 to provide an error rate for the station to which the error rate is allocated. In an illustrative embodiment of this invention, the system administrator has set a standard that any error rate of less than 10% is considered to be in compliance.

Referring now to the illustrative embodiment discussed for FIG. 2 and the maps of FIG. 9C, the above steps and the assigned stations are illustrated. In that illustrative embodiment, a shipment was picked up from the shipper at Irvine, Calif. by a system employee and taken to the HAWB origin station 11a in Garden Grove Calif., moved to the MAWB origin station 11b in the Los Angeles International Airport by a system employee, moved from LAX to the MAWB destination station 11c at the Dallas/Fort Worth International Airport by American Airlines, moved from the station 11c in Dallas/Fort Worth to the HAWB destination station 11d in Abilene by a system employee, and delivered to the consignee in Midland from the Abilene station by a system employee.

Based on the earlier discussed tables showing the responsibility of entering core data elements, the responsibilities for that shipment would break down as follows:
HAWB (House Air WayBill) Origin station 11a=Garden Grove

Garden Grove is responsible for the entry of 28 core data elements regarding the shipment.
MAWB (Master WayBill) Origin station 11b=Los Angeles

Los Angeles is responsible for the entry of 8 core data elements regarding the shipment.
MAWB (Master WayBill) Destination station 11c=Dallas/Fort Worth

Dallas/Fort Worth is responsible for the entry of 2 core data elements regarding the shipment.
HAWB (House Air WayBill) Destination station 11d=Abilene

The Abilene station 11d is responsible for the entry of 6 core data elements regarding the shipment.

In this illustrative example, the Abilene station 11d (the HAWB destination) entered 5 core data elements for the shipment. The program running in step 210 examined the 6 core data elements that the Abilene station 11d was responsible for and determine how many data elements actually had data entered in them (5). It then divides the number of elements that contain data by the number of elements that should contain data (5/6) to obtain the success rate of the entries (0.83 or 83%) of the Abilene station 11d. The program then subtracts this number from 100 to obtain the error rate of Abilene's entries (100−83=17) of station 11d which would be 17% for the illustrative example. Each of the other stations 11 involved with the shipment would have the same calculations performed on the core data elements for which they were responsible.

Since a single station 11 is the lowest grouping of the statistics and since a single station's statistics are based on all of the four roles it can potentially play in a shipment's shipment-cycle, a single station's statistics for a day are computed, again using the Abilene station 11d as our example.

For the day, the Abilene station 11d was responsible for the following:

1 shipment for which the Abilene station 11d was the HAWB origin.

6 shipments for which it was the HAWB destination.

0 shipments for which it was the MAWB origin.

1 shipment for which it was the MAWB destination.

Of the 28 core data elements for which a HAWB origin station 11d is responsible, Abilene made entries in all 28 fields for the one shipment for which it was the HAWB origin.

Of the 6 core data elements for which the HAWB destination station 11d is responsible, Abilene made entries in 3 of those fields on each of the 6 shipments for which it was the HAWB destination, making a total of 18 core data elements entered of the 36 it was responsible for.

Of the 8 core data elements for which a MAWB origin station 11d is responsible, Abilene had no shipments for which it was responsible.

Of the 2 core data elements for which a MAWB destination station 11d is responsible, Abilene made entries in both fields for the one shipment for which it was the MAWB destination.

Overall, the Abilene station lid was responsible for 66 core data elements for the day. It entered 48 of those elements. This means that it entered 73% of the core data elements for which it was responsible on that day. Conversely, the error rate for the Abilene station 11d will be displayed as 27%, which is below the standard set by the system administrator.

Referring back now to FIG. 9A, once these station-level statistics have been determined, those statistics, in step 212, are copied into three data areas of the shipment history database 43 used for the creation of reports. These three data areas contain the statistics for, respectively, the current day, the current week and the current month. Once these data areas have received the statistical information, another program in step 214 reads the data from these three data areas and formats the data from each into a group of reports that cover the date range of the data area from which the statistics were read (daily, weekly, monthly). Each of these date groupings include station-level, country-level, and region-level statistics. In an illustrative embodiment of this invention, each of these levels is further divided into 2 reports; one specific to shipments moved by air transport and the other specific to shipments moved by ocean transport.

In step 216, the data warehouse computer 40 links to the web server 23 via the corporate network 22. In step 218, the data warehouse computer 40 transfers the files containing the compliance statistics reports to the memory 26 for web pages for compliance reporting on the web server 23, where they can then be accessed by a system employee as will be described in further detail below.

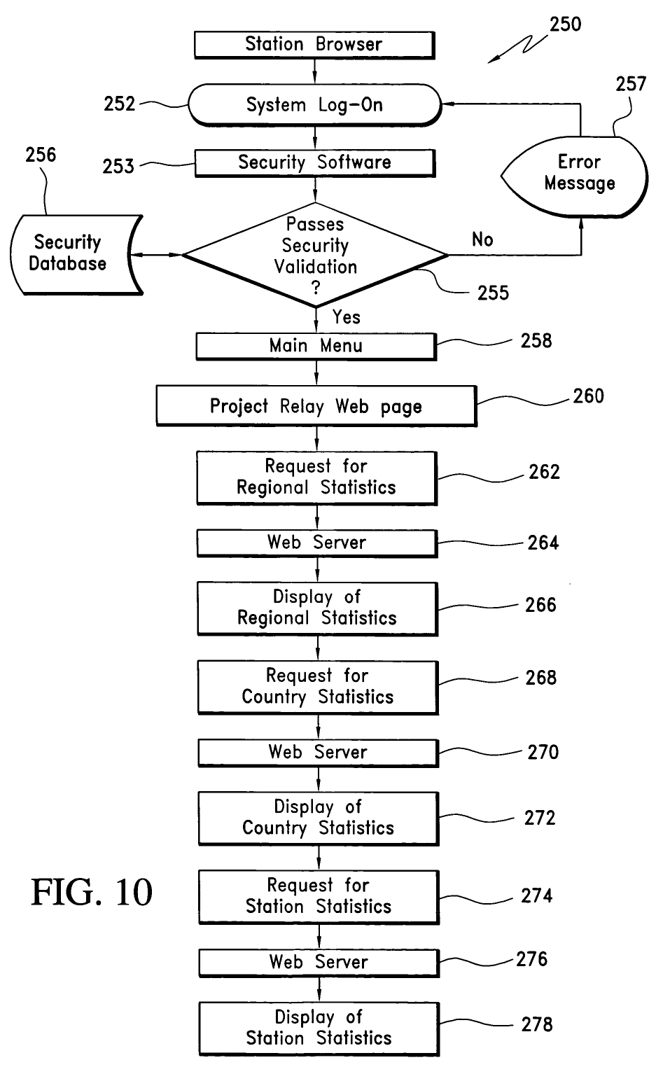

Referring now to the flow chart of FIG. 10, a method 250 is shown for requesting and displaying compliance reporting statistics from the data warehouse computer 40 as shown in FIG. 1, whereby a system employee calls up a piece of browser software 16 and initiates a connection through the internet 20 to the web server 23. When the connection is made, the system employee in step 252 is shown a system log-on screen 140 as shown in FIG. 5A, whereby the system employee is prompted to enter its unique corporate e-mail address in a data entry field 142 and its password in data entry field 144. In step 253, the system employee's entries are passed to the security software for validation. In step 255, the entered system employee's e-mail address and password are compared in step 256 with a database of authorized system employees or agents' e-mail addresses and passwords and, if there is a match, access to the system 10 is granted. If there is no match as determined in step 255, access is not granted, the system 10 displays an error message in step 257, and the system employee is returned to step 252 where the system log-on screen 140 is again displayed.

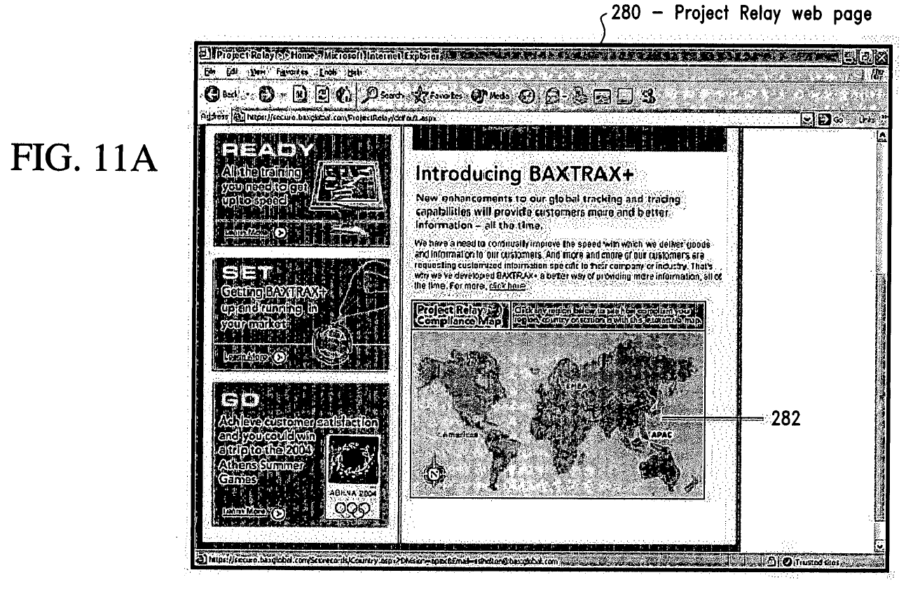

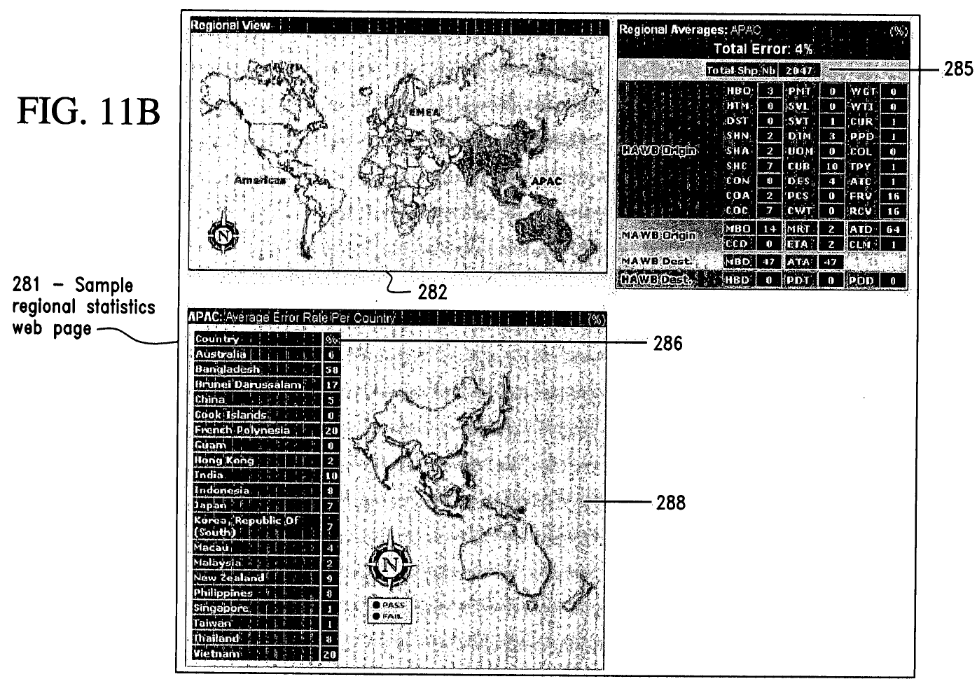

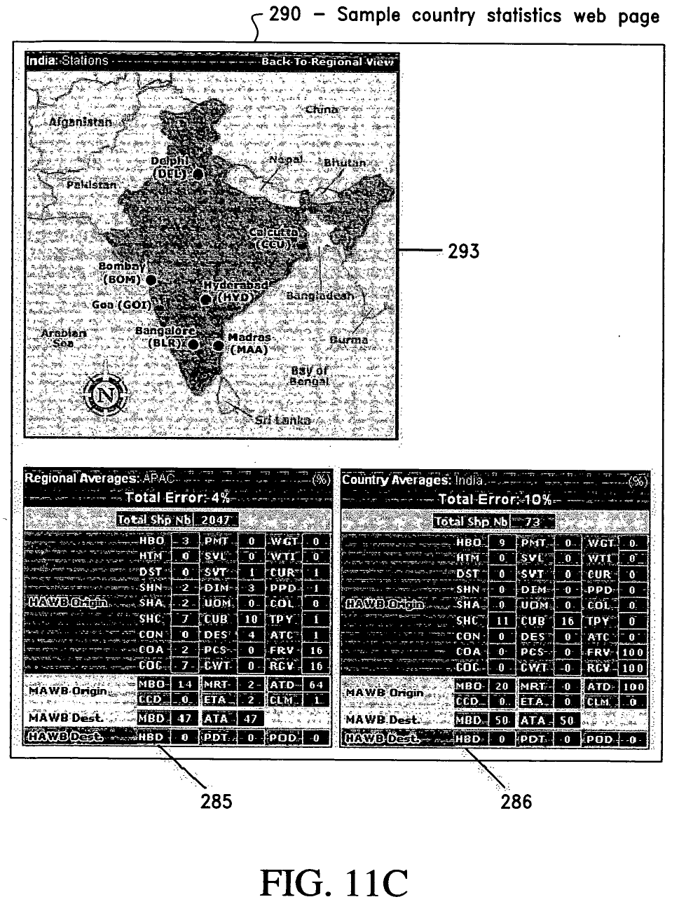

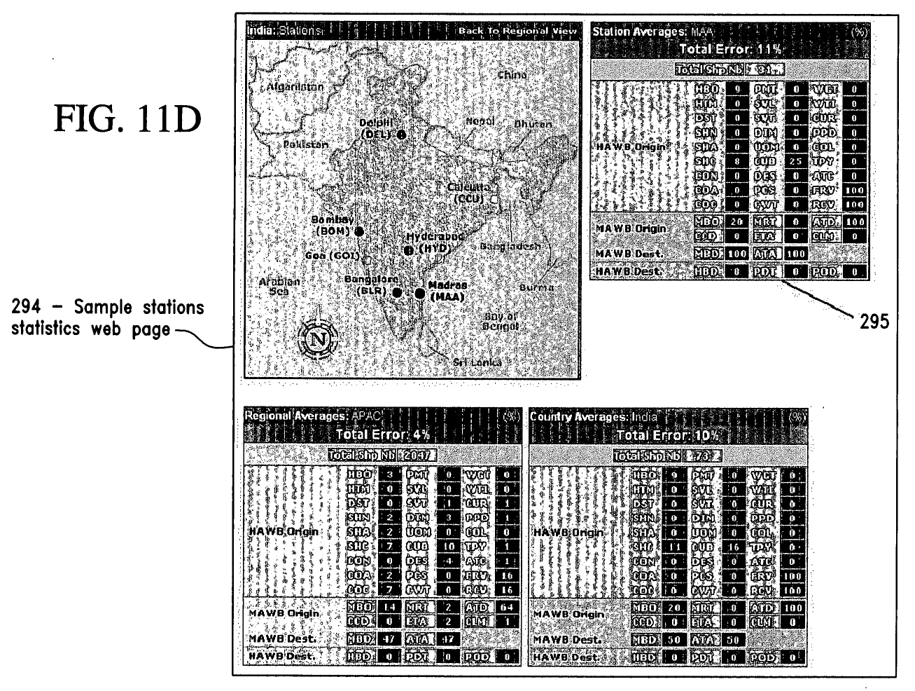

Once access is granted in step 255, then a main menu 146 for the system 10 which is stored in the memory 26 for web pages for compliance reporting is displayed in step 258 as shown in FIG. 5B, which lists the plurality of systems to which the employee has been granted access. One of these choices is labeled “Project Relay” 149 as shown in FIG. 5B and the employee would select his or her choice in step 260 to be taken to a Project Relay screen 280 shown in FIG. 11A which is stored in the memory 26 for web pages for compliance reporting and which includes a world map 282 divided into regions.

The system employee then, in step 262, clicks on the region of the world shown in the world map 282 for which he or she wants to see compliance statistics and, in step 264, the web server 23 accesses the statistics found in the region-level summaries, previously loaded to the web server 23 from the data warehouse computer 40. In step 266, the web server 23 then sends that data to the memory 26 for the compliance reporting web pages, where they are displayed on a screen 281 as shown in FIG. 11B next to the map of the world 282. This display lists the number of shipments in field 285 that are the base of the statistics, and a region-level summary of the core data elements which are displayed in “dashboard” fashion. In an illustrative embodiment of this invention, items illustratively displayed in green (not shown) are compliant with an error rate of 10% or less and items in red (not shown) do not meet the level of compliance set by the system administrator. Also displayed in field 286 is a list of the countries in that region and the error rates for each of the countries, in “dashboard” fashion, next to a map of the region as displayed in field 288, below the map of the world 282.

The system employee then, in step 268, clicks on the name of a county in that list and, in step 270, the web server 23 accesses the statistics found in the country-level summaries, previously loaded to the web server 23 from the data warehouse computer 40. In step 272, the web server 23 then sends that data to the memory 26 for web pages for compliance reporting, where they are displayed on a screen 290 as shown in FIG. 11C. This view shows the region-level statistics in field 285, shown earlier, followed by the country-level statistics in field 286. These appear below a map of the country in field 293 which shows the location of the company's stations in that country.

The system employee then, in step 274, clicks on a specific station as shown in the map and, in step 276, the web server 23 accesses the statistics found in the station-level summaries, previously loaded to the web server 23 from the data warehouse computer 40. In step 278, the web server 23 then sends that compliance data to the memory 26 for web pages for compliance reporting, where they are displayed on a screen 294 as shown in FIG. 11D. This view shows the same view as the country-level summary, with the addition of the specific station statistics shown in the upper right corner 295.

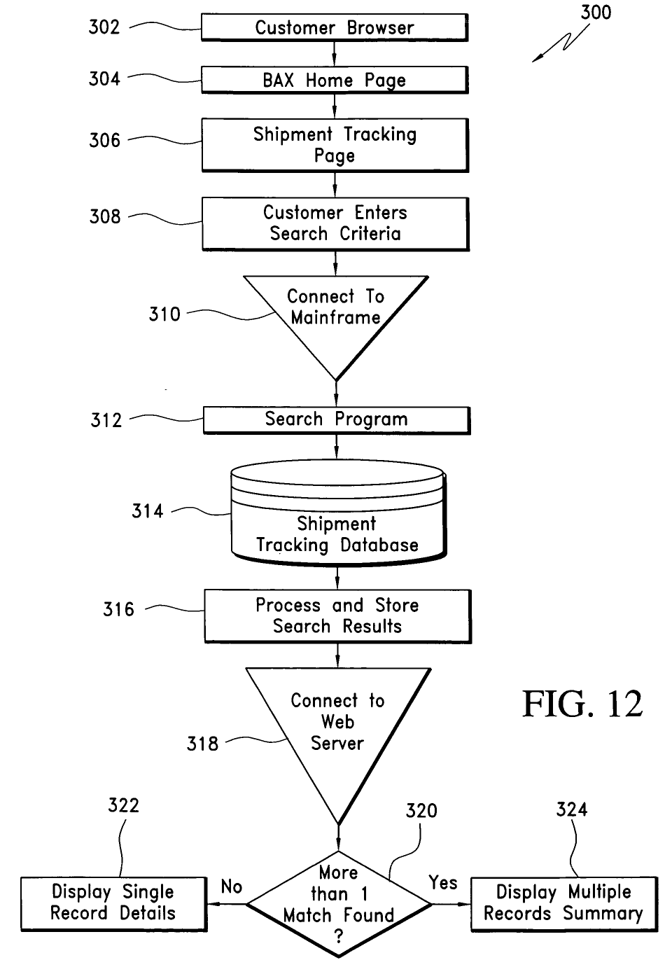

Referring now to the flow chart of FIG. 12, a method 300 is shown for a customer to request real-time information on a shipment or shipments by using their browser 16″ to access the memory 28 for web pages for customer reporting stored in the web server 23 as shown in FIG. 1. This method is an example of one of many ways that customers can receive information concerning their shipments and is used here as an illustrative example of a real-time report request.

Specific codes are used by the system to identify milestones that occur in the life-cycle of a shipment. Some of these codes are entered automatically by the system 10 and others are entered by the system employee. An example of a system-entered code is as follows: When the system employee has entered shipment data for a shipment that had no previous entries, the system 10 records a code of “EN” for “entered”. An example of a system employee-entered code is as follows: When the shipment is successfully delivered, the system employee records the delivery of the shipment with a code of “DC” for “delivered to consignee”. Many codes are directly related to the entry of the core data elements. For example, the date, time and location of the receipt of the shipment at the origin station are all core data elements. Entry of these core data elements causes the system 10 to record a code of “PU” for “picked up”. A sample list of reported codes is shown in detail below.

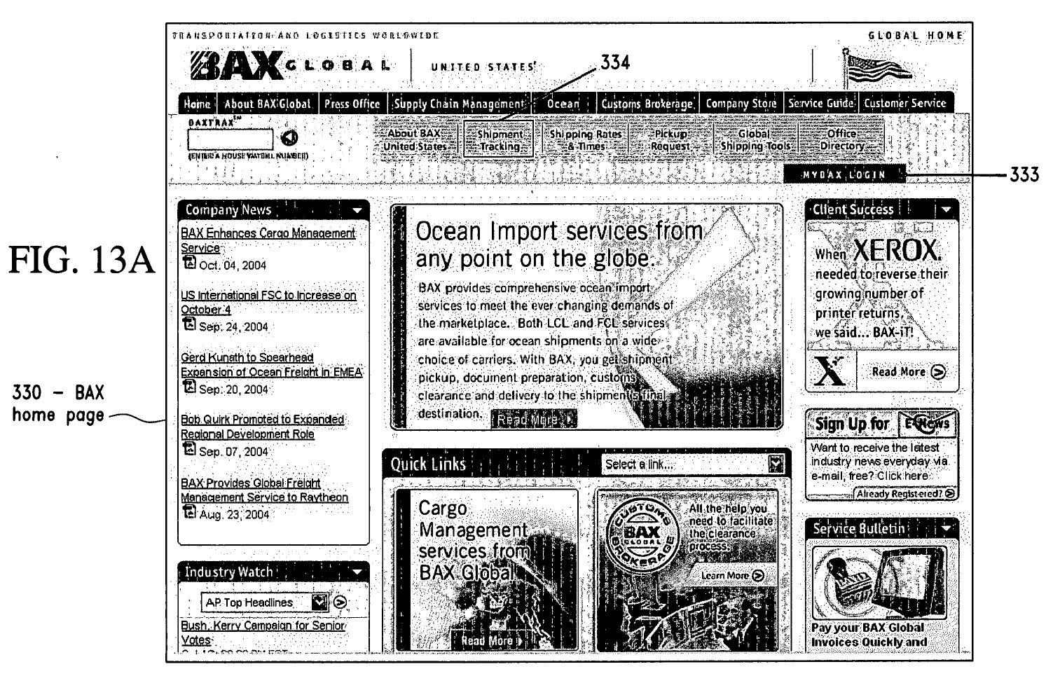

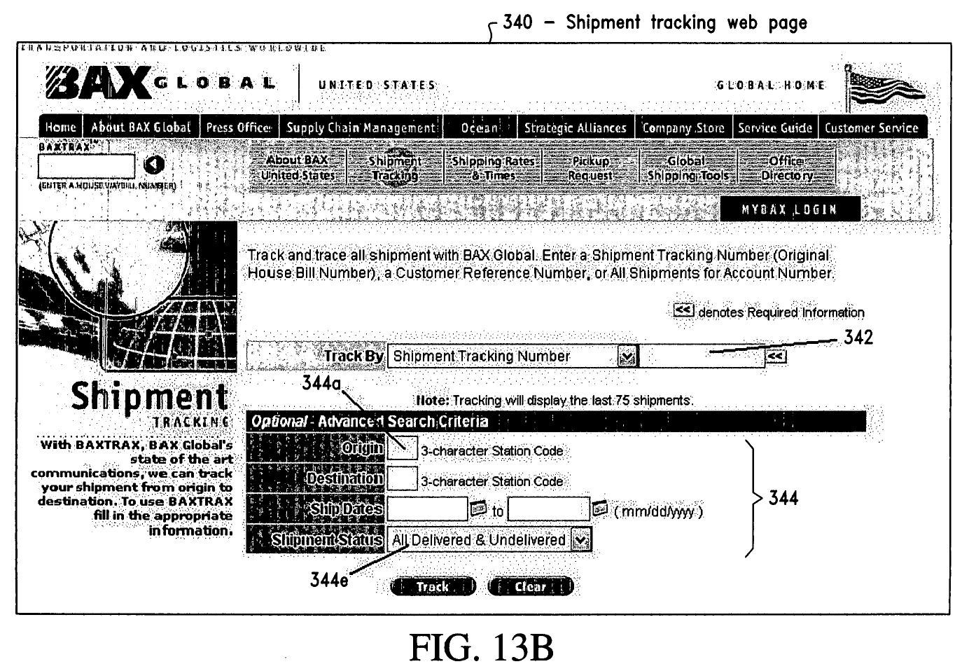

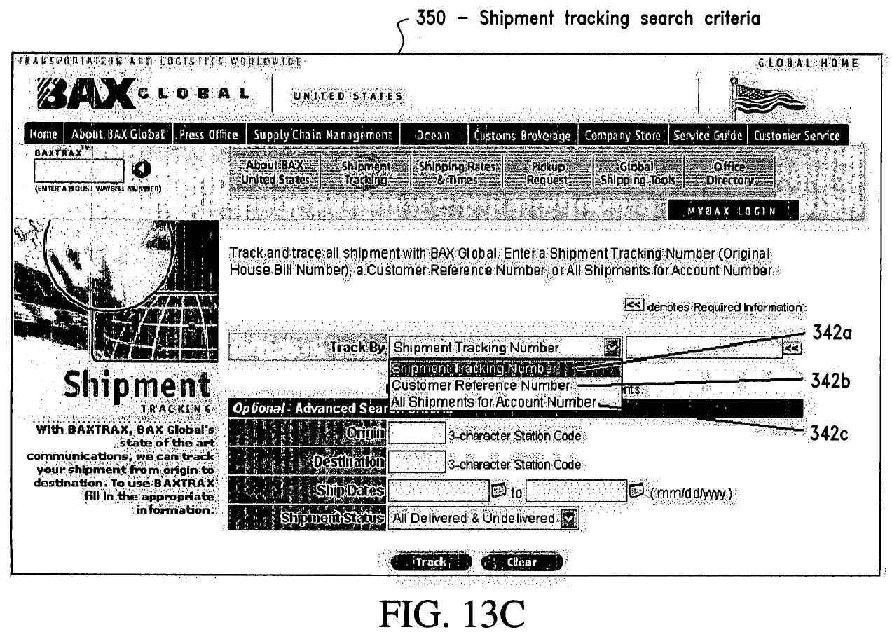

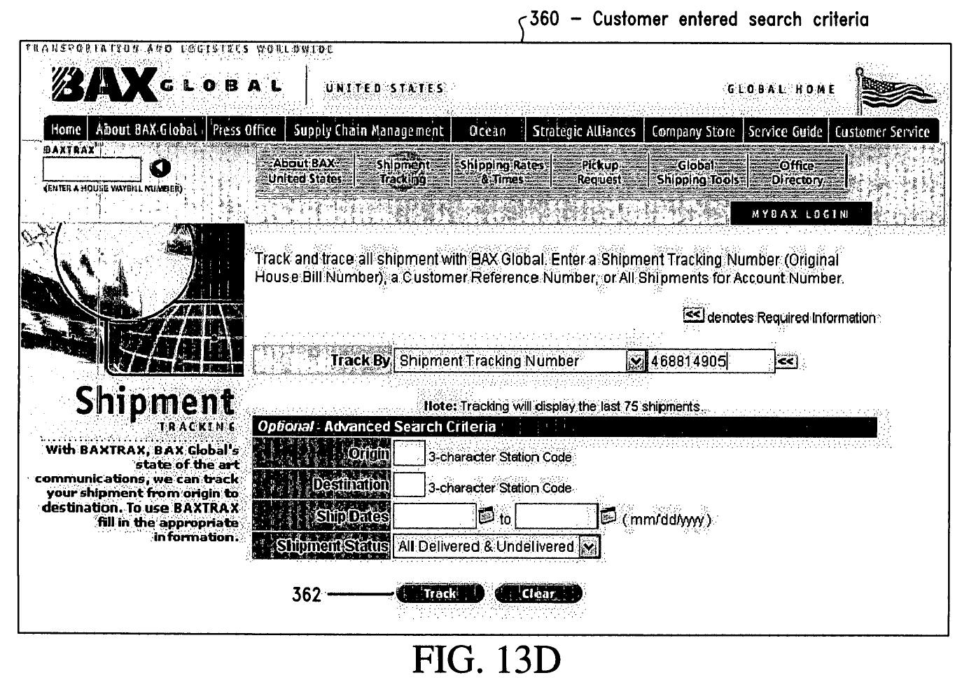

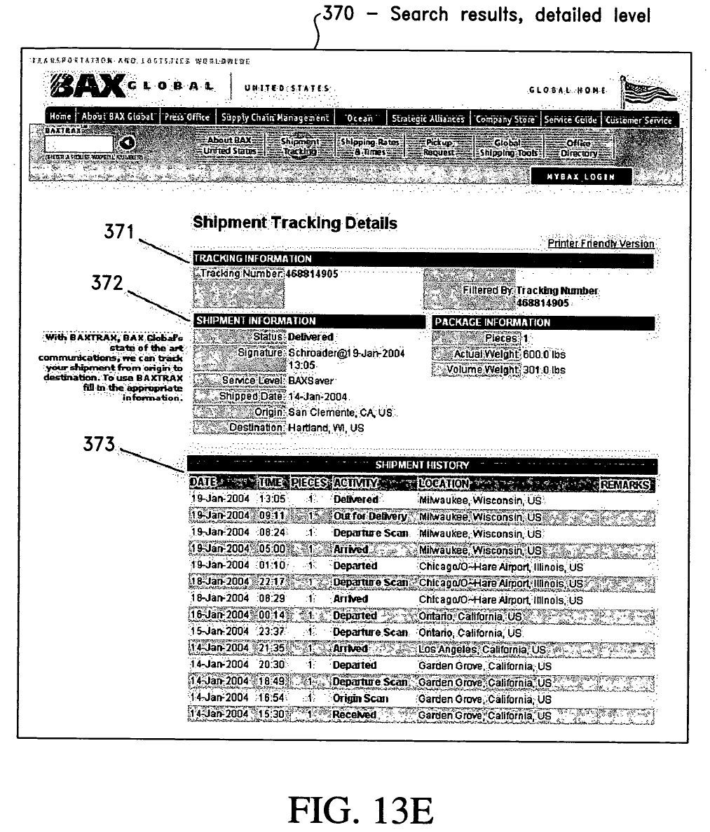

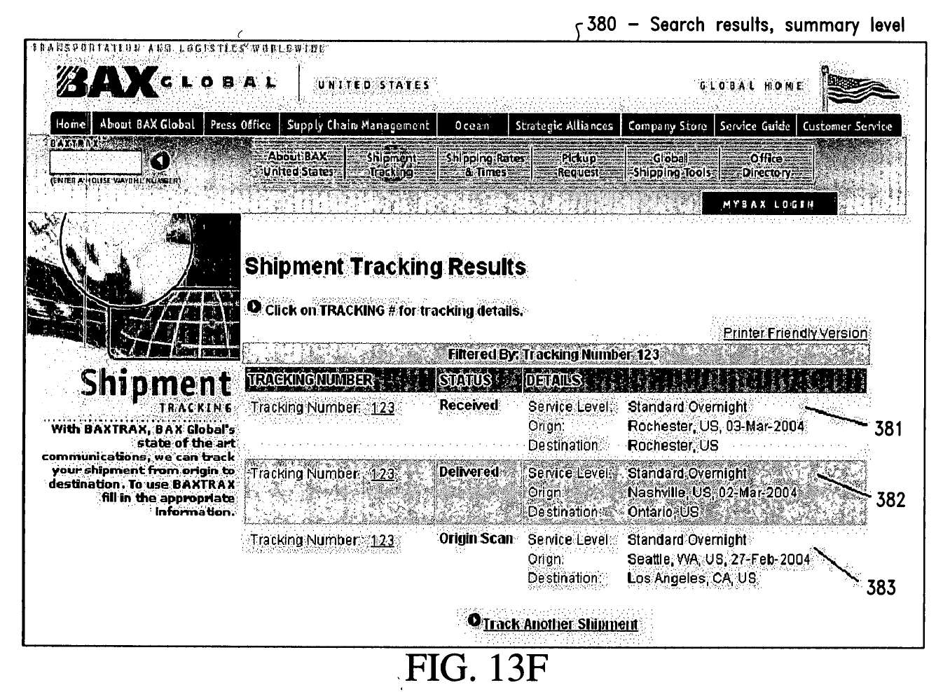

In step 302, the customer executes their browser software 16″ found on their customer terminal 38 and, in step 304, navigates to a Home Page 330 shown in FIG. 13A. From the Home Page 330, in step 306, the customer selects a link 334 as shown in FIG. 13A, to a Shipment Tracking page 340. Once the Shipment Tracking page 340 is displayed, as shown in FIG. 13B, then in step 308 the customer would enter the criteria for their tracking request, e.g., the shipping tracking number in field 342 and optional search criteria in fields 344a-e. As shown in item 336 in FIG. 13C, the criteria entered in fields 342a-c can be one of the following: Shipment Number, Customer Reference Number, or Customer Account Number. They can also enter in fields 344a-e additional, secondary criteria which can be one or more of the following: Origin station code, Destination station code, Date range of shipment, or Status of shipment. Once the customer has entered their search criteria as shown in FIG. 13D and clicked on the “track” button 362, then in step 310 the web server 23 connects to the mainframe computer 30 via the corporate network 22. In step 312, the entered search criteria is sent through the corporate network 22 to a search program stored in the shipment tracking software memory 32. In step 314, the search program uses the customer's main search criteria to query the shipment tracking database 34 for shipments that match the main criteria. Once a match has been found, it is further examined against any additional search criteria that the customer may have entered. Once a shipment record has been found to match the customer's criteria, then in step 316 the milestone codes associated with that record are identified, copied and placed in a temporary storage file while the search program continues to query the shipment tracking database 34 for more matching shipments. Once all matches have been identified, then in step 318 the collected data is sent back to the web server 23. In step 320, the web server 23 determines whether or not only one match was found. If only one shipment record was found, then in step 322 the data is displayed to the customer on a detailed-level web page 370 as shown in FIG. 13E in fields 371, 372 and 373. If there was more than one match, then in step 324 the data is displayed in a set of fields 381, 382 and 383 of a shipment tracking results screen 380 to the customer at a summary level as shown in FIG. 13F. If, when viewing the summary level display, the customer clicks on the tracking number being displayed for any matching shipment in fields 381 through 383, they are taken to the web page 370 that displays the detailed data for that shipment as shown in FIG. 13E. A complete list of reported milestone codes and their descriptions is as follows:

| MILESTONE CODE | DEFINITION |
|---|---|
| EN | Entered. |
| PU | Picked Up. |
| AM | Assigned to a MAWB. |
| CL | Closed. |
| FA | Flight arrived. |
| RV | Recovered. |
| EX | Exception. |
| QC | Quality Control Remarks. |
| AR | Additional Remarks |
| AT | Attempted Delivery |
| BD | Documents to Broker |
| CC | Cleared Customs |
| 61 | Immediate Transport |
| 62 | Transport Export |
| 63 | Immediate Export |
| IB | Delivered to Company Broker |
| IC | In Customs |
| NC | Notified Consignee |
| ND | Non-Deliverable |
| NS | Notified Shipper |
| OD | Out for Delivery |
| PD | Partial Delivery |
| RD | Refused Delivery |
| TD | Delivered to Consignee by Trucker (P.O.D.) |
| AC | Shipment Delivered by Airline |
| AD | Automatically Delivered by Argus |
| AP | Customer Pickup at the Airline |
| DB | Delivered to Broker |
| DC | Delivered to Consignee |
| DT | Delivered to Trucker |
| ED | Express Delivery |
| RR | Rerouted; or Refused and Returned |
| TC | Turned over to Claims |
| WC | ‘Will Call’; Consignee picked up shipment |
| | at terminal |

Please note that Milestone codes are dynamic and can be changed. The listing above is only an illustrative embodiment of this invention.

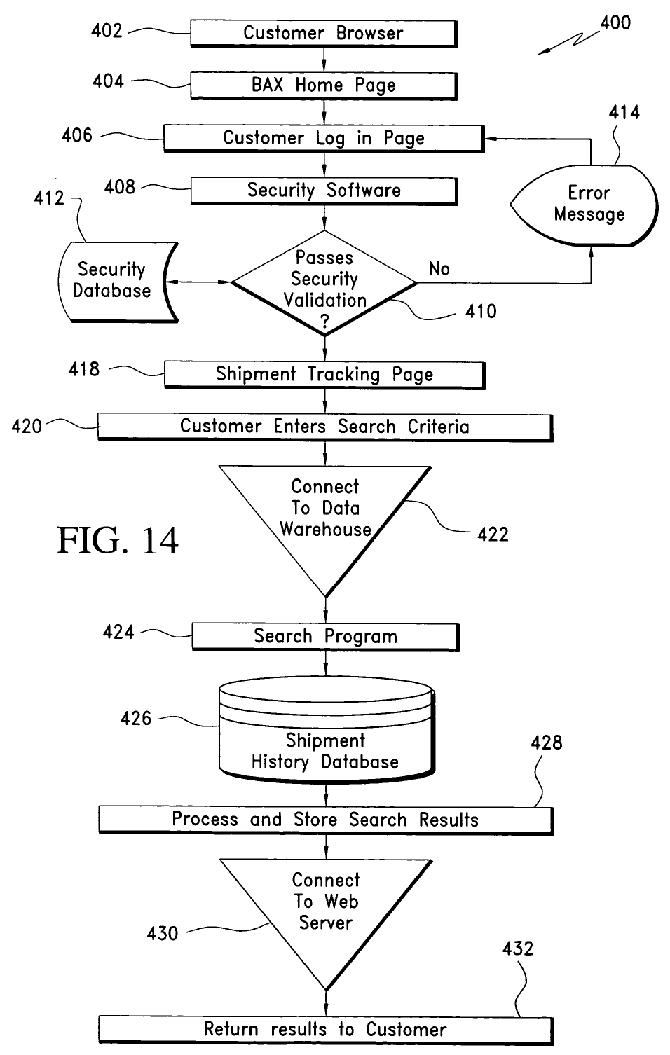

Referring now to the flow chart of FIG. 14, a method 400 is shown for a customer to request historical information on a shipment or shipments by using their browser 16″ to access the memory 28 for web pages for customer reporting stored in the web server 23 as shown in FIG. 1. This method is an example of one of many ways that customers can receive information concerning their shipments and is used here as an illustrative example of a reporting data request from the shipment history database 43.

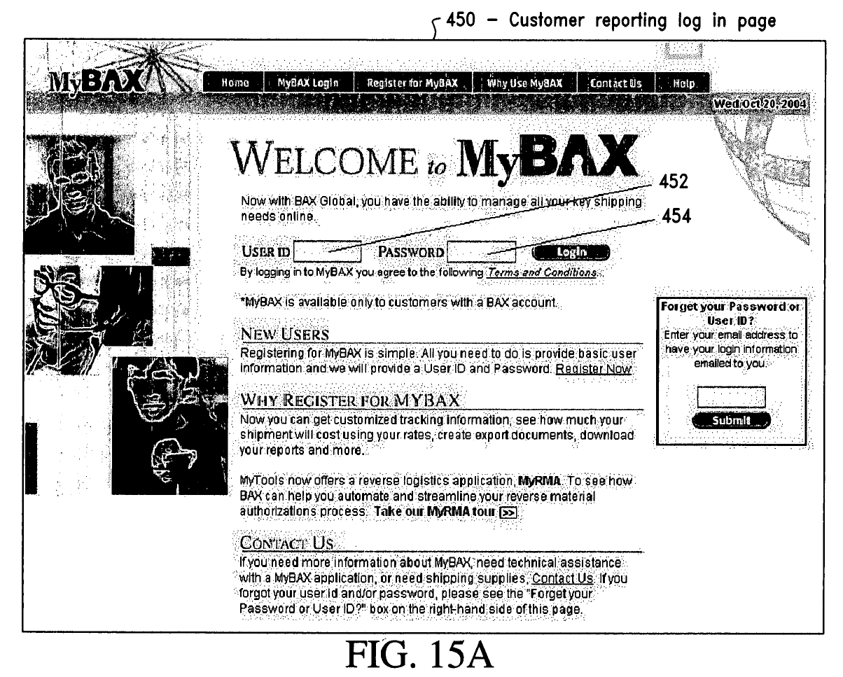

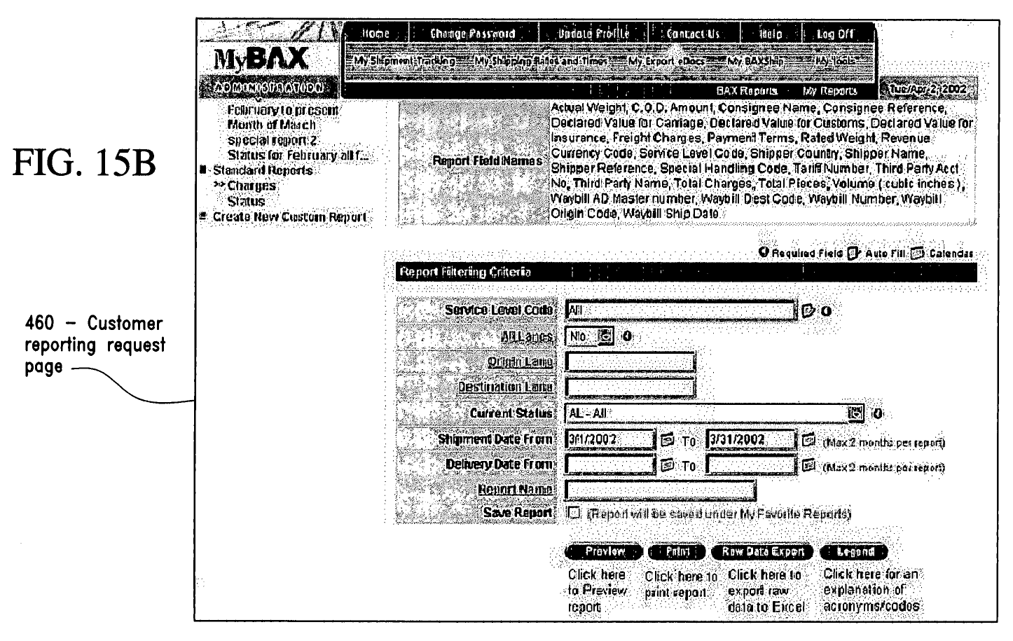

In step 402, the customer executes their browser software 16″ found on their customer terminal 38 and, in step 404, navigates to a Home Page 330 shown in FIG. 13A. From the Home Page 330, the customer selects a link 333 as shown in FIG. 13A, to the customer reporting log in screen 450 as shown in FIG. 15A. At the log in screen, the customer enters his/her ID and Password in data fields 452 and 454. In step 408, the customer's entries are passed to the security software for validation. In step 410, the entered ID and password are compared with the authorized customer IDs and passwords as stored in a security database 412 and, if there is a match, access to the system 10 is granted and the customer in step 418 is taken to the report request page 460 as shown in FIG. 15B. If there is no match as determined in step 410, access is not granted, the system displays an error message in step 414, and the customer is returned to step 406 where the system log-on screen 450 is again displayed.

Once the reporting page 460 is displayed, as shown in FIG. 15B, then in step 420 the customer would enter the criteria for their tracking request. Once the customer has entered their search criteria as shown in FIG. 15B and selected one of the processing choices listed at the bottom of the screen (preview, print, raw data export), then in step 422 the web server 23 connects to the data warehouse computer 40 via the corporate network 22. In step 424, the entered search criteria is sent through the corporate network 22 to a search program stored in the memory for compliance and reporting 41. In step 426, the search program uses the customer's search criteria to query the shipment history database 43 for shipments that match the criteria. Once a shipment record has been found to match the customer's criteria, then in step 428 the data associated with that record are identified, copied and placed in a temporary storage file while the search program continues to query the shipment history database 43 for more matching shipments. Once all matches have been identified, then in step 430 the collected data is sent back to the web server 23. In step 432, the web server 23 determines how to present the data, based on the customer's processing choice in step 420, and presents them with the processed data in the appropriate format.

Should a customer request the collection of report data that does not currently exist in the shipment tracking database 34, the system administrator has the ability to define additional data elements via a scalable data table that is a sub-set of the complete range of data found in the shipment tracking database 34. Once the system administrator defines these new data elements, they can begin to be entered immediately by system employees, and the new data elements will be captured by the system 10 in the shipment tracking database 34 and included in the extract of data to the data warehouse 40, where they become available for customer reporting.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, objects, and solutions to problems have been described above with regard to specific embodiments. However, the benefits, advantages, solutions to problems, objects, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

[symbol]

11. The method of determining the compliance statistics as claimed in claim 1, wherein there is included the further step of identifying each core date element which is related with one of the plurality of shipments.

12. The method of determining the compliance statistics as claimed in claim 11, wherein there is included the further step of examining each core data element accessed from the central computer to determine for the one shipment, which of the plurality of stations are involved in the one shipment cycle and which role each involved station plays.

13. The method of determining the compliance statistics as claimed in claim 12, wherein the step of determining whether data has been entered in each core data element examines each core data element related to the one shipment to determine if data has been entered in each core data element of the one shipment and counts the core data elements of the one shipment in which data has been entered to provide a count of the these core data elements by the terminal that entered the counted core data elements.

14. The method of determining the compliance statistics as claimed in claim 13, wherein there is further included the steps of determining for one of the plurality of terminals the number of data core elements entered by the one terminal and for each shipment, subtracts the counted number of core data element into which data has been entered by one terminal, from the total number of data core elements entered by the one terminal.

15. The method of determining the compliance statistics as claimed in claim 1, wherein step b) repeatedly accesses each core data element in the central computer until each core data element has been accessed by the central computer.

16. The method of determining the compliance statistics as claimed in claim 15, wherein after step b) has accessed each core data element in the central computer and step c) of determining and step d) of determining have been executed to determine one of the plurality of terminals, there is included the further step of counting each of the total number of core data elements in which data has not been entered.

17. The method of determining the compliance statistics as claimed in clam 16, wherein there is included the further step of dividing the total number of errors by the total number of data core elements entered by the one terminal to provide an error rate for the station related to the one terminal.

18. The method of determining the compliance statistics as claimed in claim 1, wherein there is included for the plurality of stations the further steps of identifying each shipment of the plurality of shipments as it passes through one of the plurality of stations, identifying for a predetermined interval of time each of the plurality of shipments moving to the one station during its shipping-cycle, determining for each shipment passing to the one station the number of data core elements entered by the a terminal related to the one station, and determining for each shipment passing to one station the number of date core elements which have not been filled with data.

19. The method of determining the compliance statistics as claimed in claim 18, wherein there is included the further steps of determining the total number of core data elements provided by each of the identified shipments moving to the one station and determining the total number core date elements of the identified shipments moving to the one station which were not filled with data.

20. The method of determining the compliance statistics as claimed in claim 1, wherein there is included the further steps of determining each shipment that moves in its shipment-cycle to a predetermined station, based upon the predetermined station and the shipment that moved to the predetermined station determining that each station has a corresponding role, and determining for the predetermined station and each shipment that moved to the predetermined station the number of data core-elements provided for each shipment that moved to the predetermined station.

21. The method of determining the compliance statistics as claimed in claim 20, wherein there is included the further steps of counting the number of data core-elements provided by each of the plurality of shipment that were moved to the predetermined station to provide a total number of data core-elements, and determining the number of data core-elements which were filled with data.

22. A system for collecting and monitoring shipment data, wherein one or more system administrators enters into the system shipment data that is indicative of the status of a plurality of shipments as at least one shipment is moved through a shipment-cycle, the shipment data reflecting the attributes of each shipment and/or events occurring to each shipment during its shipment-cycle, the collecting and monitoring system comprising:
a) a first plurality of synchronous terminals, each of the plurality of synchronous terminals comprises a browser and an emulator;
b) a second plurality of non-synchronous terminals, each of the plurality of non-synchronous terminals comprises at least one data input system and a non-synchronous terminal memory;
c) first and second data transmission networks, each of which transmits there over the shipment data from one of the terminals;
d) a central computer comprising a shipment tracking database for receiving and storing shipment data therein, and a shipment tracking program memory for storing a program for receiving and storing shipment data in the shipment tracking database;
e) a web server comprising a webpage memory for storing web pages for facilitating the service provider's entry of shipment data into the shipment tracking database; and
f) the emulator being actuated by at least one of the service providers to execute the program stored in the shipment tracking program memory to connect the emulator to the central computer by the first data transmission network to enter shipment data into the shipment tracking database, and the browser being actuated by the one service provider to connect the browser by the second data transmission network to the webpage memory whereby the service provider may display at least one webpage to facilitate the one service provider to enter shipment data over the second data network to the shipment tracking database, each of the data input systems is non-synchronous with respect to each of the web server and the central computer, whereby shipment data is inputted from the data input system into the shipment tracking database by the first transmission data network.

23. The system for collecting and monitoring as claimed in claim 22, wherein at least one of the administrators prompts one of the data input systems to enter parcel starter data in the non-synchronous station memory, the one data input system determines whether the administrator has requested a transmission of the parcel status data or if an internal trigger has been provided by the data input system and if so, the newly entered parcel status data is transmitted to the non-synchronous station memory.

24. The system for collecting and monitoring as claimed in claim 23, wherein the data input system copies a sub-set of the parcel status data residing in the non-synchronous station memory into a flat-file to be transmitted over the first data transmission network to the mainframe computer

25. The system for collecting and monitoring as claimed in claim 24, wherein the mainframe computer executes the program stored in the parcel tracking software memory to open the flat-file and to extract the parcel data there from.

26. The system for collecting and monitoring as claimed in claim 25, wherein the mainframe computer continues to execute the program stored in the parcel tracking software memory to examine the parcel status data from the flat-file to determine if an error exists and if an error exists, the extracted parcel status data is rejected and a report of information about the error is constructed and displayed.

27. The system for collecting and monitoring as claimed in claim 25, wherein if no errors are detected by the mainframe computer, the mainframe computer transmits the parcel status data from the flat-file to the parcel tracking database.

28. The system for collecting and monitoring as claimed in claim 21, wherein each data input system responds to the receipt of the parcel status data by storing the changed parcel status data in the non-synchronous station memory.

29. The system for collecting and monitoring as claimed in claim 28, wherein the data input system determines whether a system administrator has manually requested a transmission or an internal trigger has activated the transmission of parcel status data via the first data transmission network to the main frame computer.

30. A system for collecting and monitoring shipment data, wherein one or more service providers can enter into the system shipment data that is indicative of the attributes of a plurality of customer shipments as one or more customers forwards at least one customer shipment through a shipment-cycle, the shipment data reflecting the attributes of each customer shipment and/or events occurring to at least one customer shipment during its shipment-cycle, the collecting and monitoring system comprising:
a) a plurality of customer terminals, each customer terminal comprising a customer display, a customer computer and a customer data input device, the customer computer being programmed to facilitate the customer to input using its data input device a request for the shipment data of one or more of the customer's shipments;
b) a web server comprising a server memory for storing web pages for facilitating at least one customer to enter a request for shipment data;
c) a central computer comprising a shipment tracking data base for receiving and storing shipment data, the central computer being programmed for receiving and storing shipment data in the shipment tracking data base; and
d) a plurality of disparate shipment data input terminals for entering shipment data into the system, at least one of the plurality of shipment data input terminals has a synchronous terminal computer which is programmed to operate synchronously with respect to the web server and the central computer, and at least another of the plurality of shipment data input terminals has a shipment data input memory and an asynchronous terminal computer which is programmed to operate asynchronously with respect to the web server and the central computer to determine whether the inputted shipment data represents a change in the attribute and/or the status of the customer shipment and, if so, to store the received shipment data in the shipment data input memory and to download the inputted shipment data from the shipment data input memory to the shipment tracking data base.

31. The system for collecting and monitoring as claimed in claim 30, wherein the terminal computer of each of the plurality of disparate shipment data input terminals is programmed to assign at least one status code to each shipment data to indicate if the events have occurred to at least one shipment as the one shipment moves through its shipment-cycle.

32. The system for collecting and entering monitoring as claimed in claim 30, wherein the asynchronous terminal computer is further programmed to determine if the physical attributes of the shipment have changed or if an event has occurred to at least one shipment as it moves through its shipment-cycle to generate a trigger and to determine whether a service provider administrator has manually actuated a request for a transmission of the shipment data or an internal trigger is generated to request the transmission of the shipment data to the central computer.

33. The system for collecting and monitoring as claimed in claim 32, wherein the asynchronous terminal computer is further programmed to determine whether a trigger has been activated or the service provider has requested a manual transmission, and, if so, then transfer the shipment data to the shipment data input memory.

34. The system for collecting and monitoring as claimed in claim 33, wherein the asynchronous terminal computer is further programmed to copy and store a sub-set of the shipment data into a flat-file, before initiating a data connection via a data transmission network to the central computer.

35. The system for collecting and monitoring as claimed in claim 34, wherein the central computer is further programmed to determine when the data transmission network interconnects the other shipment data input terminal and the central computer and, when connected, the other shipment data input terminal transfers the flat-file through the data transmission network to the central computer.

36. The system for collecting and monitoring as claimed in claim 35, wherein the central computer is further programmed to open the flat-file upon its receipt in the central computer and to extract the shipment data from the flat-file.

37. The system for collecting and monitoring as claimed in claim 36, wherein the central computer is further programmed to compare the extracted shipment data with a transmission specification to determine whether the extracted parcel data differs from the transmission specification thereby indicating an error in the extracted shipment data.

38. The system for collecting and monitoring as claimed in claim 37, wherein the central computer in further programmed to determine that the extracted shipment data matches the transmission specification to permit the flat-file to be transmitted to the shipment tracking data base.

39. The system for collecting and monitoring as claimed in claim 38, wherein each of the plurality of disparate shipment status data input terminals compares its extracted shipment data with the same transmission specification to ensure that the entire system is using the same data format.

40. A system for collecting and entering shipment status data into the system, the shipment status data is indicative of the status of at least one customer shipment which one or more customers forwards through a shipment-cycle, the shipment status data reflecting selected events occurring to at least one shipment during its shipment-cycle, wherein the collecting and entering system comprises:
a) a central computer comprising a shipment tracking database for receiving and storing the shipment status data, the central computer being programmed to receive and store shipment status data into the shipment tracking data base;
b) a data input for assigning a status code to identify the physical position where each of the selected events occurs and for transmitting in real time via a data transmission network the shipment status data and the assigned status codes to the shipment tracking database;
c) a plurality of customer terminals, each customer terminal comprising a customer display, a customer computer and a customer data input device, said customer computer being programmed to facilitate the one customer to input using its data input device at least one request for the shipment status data of the one customer's shipment(s); and
d) a web server comprising a server memory for storing web pages for facilitating the one customer to enter a shipment status data request for the shipment status data of the one shipment of the one customer.

41. The system for collecting and entering shipment status data as claimed in claim 40, wherein the one customer enters using the customer data input device a search criteria of the one customer's shipment.

42. The system for collecting and entering shipment status data as claimed in claim 41, wherein the central computer being further programmed to respond to the search criteria to construct and transmit to the shipment tracking data base the shipment status data request to identify all of the shipment(s) stored in the shipment tracking data base that corresponds to the search criteria entered by the one customer.

43. The system for collecting and entering shipment status data as claimed in claim 42, wherein the central computer being further programmed to respond to the shipment status data request by providing an output message comprising the corresponding shipment(s).

44. The system for collecting and entering shipment status data as claimed in claim 43, wherein the central computer being further programmed to transmit the output message via a data transmission network to the web server, which constructs a web page to be downloaded to a corresponding one of the customer terminals for display of the output message to the one customer.

45. The system for collecting and entering shipment status data as claimed in claim 41, wherein the central computer being further programmed to respond to the search criteria to search the shipment status data stored in the shipment tracking data base and to identify each shipment as stored therein that corresponds to the search criteria.

46. The system for collecting and entering parcel status data as claimed in claim 45, wherein the central computer being further programmed to access the assigned status codes associated with each of the parcels corresponding to the entered search criteria.

47. The system for collecting and entering shipment status data as claimed in claim 45, wherein the central computer being further programmed to connect the central computer to the web server to transmit thereto the output message, and processing the time sequenced message to provide a web page that embodies the output message, and to store the webpage in the server memory, and the web server being programmed to facilitate the customer entering its search criteria to access the web server and display the output message to the customer providing the request.

48. The system for collecting and entering parcel status data as claimed in claim 42, wherein the selected events correspond to a plurality of locations, which define the shipment-cycle of the one shipment.

49. A system for collecting and entering shipment data into the system, the shipment data is indicative of the confidential attributes of each of the plurality of shipments, each of the plurality of shipments being forwarded by a related customer, wherein the collecting and entering system comprises:
a) a web server comprising a web page memory for storing web pages for facilitating each of the plurality of customers to enter a request for the shipment data of at least one of the customer's shipments;
b) a plurality of customer terminals, each customer terminal comprising a customer display, a customer computer and a customer data input device;
c) a data warehouse computer comprising a warehouse database for receiving and storing the shipment data; and
d) the data warehouse computer being programmed to respond to the receipt of the request for the shipment data by prompting the one customer to input its password, to compare the one customer's pass word with a plurality of valid customer passwords and, if there is a match, prompting the one customer to enter its search criteria, and construct and apply a search request for the entered search criteria to search the shipment data stored in the warehouse data base to provide a list of one or more shipments with attributes that match the customer's search criteria.

50. The system for collecting and entering shipment data into the system as claimed in claim 49, wherein the warehouse computer being programmed to receive search criteria including date ranges, types of services, cost of service and security.

51. The system for collecting and entering shipment data as claimed in claim 49, wherein there is further included a data input for inputting and storing shipment data in the warehouse data base; and the data input comprises a central computer which comprises a shipment tracking database for receiving and storing the shipment data, the central computer being programmed to receive and store shipment data into the warehouse data base.

52. The system for collecting and entering parcel status data as claimed in claim 51, wherein the central computer being programmed to copy and repetitively transfer at a predetermine interval the content of the shipment tracking data base to the warehouse data base.

53. The system for collecting and entering shipment data as claimed in claim 52, wherein there is further included a plurality of disparate shipment data input terminals for entering shipment data into the shipment tracking data base.

54. The system for collecting and entering shipment parcel status data as claimed in clam 52, wherein the central computer being programmed to time date when each shipment is entered into the shipment tracking data base and to copy and transfer those shipment data elements that have a time date later than the last time the shipment data elements were copied and transferred to the warehouse data base.
